(19) United States
(12) Patent Application Publication
(10) Pub. No.: US 2020/0250602 A1
(43) Pub. Date: Aug. 6, 2020

(54) SYSTEM AND METHOD FOR HIGH-MIX WHEELS FOR CAPACITY PLANNING RESOURCE PLANNING AND MATERIAL RESOURCE PLANNING

(71) Applicant: Camelot ITLab GmbH, Mannheim (DE)

(72) Inventors: Josef PACKOWSKI, Heidelberg (DE); Steffen JOSWIG, Laudenbach (DE); Tobias HECKMANN, Eppelheim (DE)

(21) Appl. No.: 16/783,722

(22) Filed: Feb. 6, 2020

Related U.S. Application Data
(63) Continuation of application No. 15/098,606, filed on Apr. 14, 2016, now abandoned.
(60) Provisional application No. 62/149,231, filed on Apr. 17, 2015.

(51) Int. Cl. G06Q 10/06

(52) U.S. Cl. CPC G06Q 10/06314; G06Q 10/06315; G06Q 10/06393

(57) ABSTRACT

A system and method for enhance planning concepts by adding High-Mix Wheels to the feature set of existing SAP ERP/SCM system landscapes and may also combine planning concepts with an automatic material resource planning (MRP) and capacity resource planning (CRP) logic enhanced by factoring algorithms. This is the first time that MRP, CRP and factoring against constraints can be done in one single planning step, enabling better and faster planning results. Extreme tight integration of planning optimization based on Lean paradigm is provided that may include enhanced Lean Planning algorithms that extend rhythmic planning.

### CROSS-REFERENCE TO RELATED APPLICATIONS

This application claims benefit and priority to U.S. Provisional Application No. 62/149,231 filed Apr. 17, 2015, the disclosure of which is incorporated by reference herein in its entirety.

### BACKGROUND

### Field of the Invention

The present disclosure generally relates to material resource planning and capacity resource planning and, more particularly, to a system and method for providing high-mix wheels to material resource planning and capacity resource planning, among other features.

### 2.0 Related Art

Current planning algorithms support only classic wheels, i.e., fixed duration of the wheel and fixed production quantity of every product in a company's existing SAP® ERP/SCM system, or similar system. Actual planning with classic wheels is based solely on the design. The High-Mix Rhythm Wheel also includes current netting situation. Moreover, levelling capacity versus demand is done in an iterative way and not in one step, reducing optimization options and also reducing performance. Additionally, manual adjustments are applied after the scheduling, reducing the possible effect of factoring.

### SUMMARY OF THE DISCLOSURE

The present disclosure overcomes the limitations and problems as described above.

In one aspect, LEAN Suite features described herein may enhance known Lean Planning concepts by adding High-Mix Wheels to the feature set and may also combine Lean Planning concepts with an automatic MRP (material resource planning) and CRP (capacity resource planning) logic enhanced by factoring a thins. Lean Planning may now be executed in the application, including design, optimization, execution and monitoring of the Lean Planning process. Furthermore, as part of the features of the present disclosure, this is the first time that MRP, CRP and factoring against constraints can be done in one single planning step, enabling better and faster planning results. Also, extremely tight integration of planning optimization based on Lean Planning paradigm that may include enhanced Lean Planning algorithms that extend rhythmic planning.

In one aspect, the present disclosure includes one-step finite scheduling, including MRP & CRP, as well as freely interchangeable factoring methods in one cycle, thereby reducing run times compared to a standard infinite MRP process by around a factor of 2; and for the current standard planning procedure finite MRP with additional scheduling heuristic) by a factor of 5 to 20 for same system basis and hardware. The system and method described in the present disclosure may include Customizable Factoring Methods (influencing the scheduling result). The present disclosure includes High-Mix Rhythm Wheels. In contrast, up to now, only static Rhythm Wheels have been used.

In one aspect, the present disclosure includes a Rhythm Wheel Designer module that provides setup optimization procedures against actual demands costs and capacity constraints; optimization of Rhythm Wheels also against setup/overall costs; optimization including multi-stage stock optimization with synchronized Rhythm Wheels across different production stages; and support of different Rhythm Wheel types Classes, Breathing, High-Mix, in one tool.

In one aspect, the present disclosure includes a Rhythm Wheel Heuristic module that provides for fully integrated in-memory calculation of planning; automatic scheduling algorithms, including MRP, CRP and various factoring methods in one go, thereby supporting different Wheel types in one application. The present disclosure also includes a Rhythm Wheel Monitor module that comprises an integrated tool to compare Rhythm Wheel Design versus Rhythm Wheel Schedule against current netting settings.

The features of the present disclosure may provide far better performance, such as, e.g., allowing not only nightly batch schedules, but also fully optimized runs over the working time with the option to do several iterations by the planners in case of design changes. Moreover, dramatic reduction of the bullwhip effect on upstream production stages may be achieved by using high-mix rhythm wheels. This may provide for a Higher OEE (overall equipment effectiveness) with an ROI (return on investment) of up to 4 Mio for a resource.

In one aspect, a system for advanced material resource planning and capacity resource planning comprises a rhythm wheel designer subsystem executing on a supply chain planning system that creates an optimal rhythm wheel design based on actual production requirements and availability of production resources using at least one sequence optimization algorithm of a plurality of sequence optimization algorithms, selectable by a user, and a rhythm wheel heuristic subsystem executing on an enterprise resource system that initializes a wheel including planning parameters, pre-calculate cycles including netting and factoring, schedules a cycle and produces a rhythm wheel log based on the optimal rhythm wheel design for controlling a production manufacturing process. The system may further include a rhythm wheel log subsystem that creates a sequence optimized material resources planning (MRP) and capacity requirements planning (CRP) production plan based on the rhythm wheel log for controlling a production manufacturing process. The rhythm wheel log subsystem may output key performance indicators to a data warehouse.

The system may further comprise a rhythm wheel monitor subsystem to accept data from the rhythm wheel log subsystem to display planning results and key performance indicators to one or more display devices. The at least one sequence optimization algorithm may comprise a plurality of optimization algorithms selected from the group of: sequence optimization, ant colony sequence optimization, simulated annealing sequence optimization and absolute minimum sequence optimization. The rhythm wheel heuristic subsystem may perform factoring if an actual required total cycle length of a created production schedule exceeds or falls below a predefined maximum or minimum cycle length. The factoring may reduce replenishment quantities which cover actual net requirements to fit actual constraints. The actual constraints may comprise one or more of: resource capacity, component availability and order prioritization cycle time definitions. The rhythm wheel designer subsystem may provide selectable optimization techniques for calculation of sequences and optimal cycle time. The selectable optimization techniques for calculation of sequences and optimal cycle time may include set-up time for overall equipment efficiency (OEE). The selectable optimization techniques for calculation of sequences and optimal cycle time may include production costs. The rhythm wheel designer subsystem may support a classic wheel rhythm wheel, a breathing rhythm wheel and a high-mix rhythm wheel. The rhythm wheel designer subsystem may outputs a centralized status display area to convey: a first status indicator that at least one product data structure (PDS) exists which is valid for a whole wheel horizon, a second status indicator during the whole wheel horizon at any time at least one valid PDS exists and a third status indicator indicating that there is at least one time period where no valid PDS exists.

In one aspect, a system for advanced material resource planning and capacity resource planning may comprise a rhythm wheel designer subsystem executing on a supply chain planning system that creates an optimal rhythm wheel design based on actual production requirements and availability of production resources using at least one sequence optimization algorithm of a plurality of sequence optimization algorithms, selectable by a user, a rhythm wheel heuristic subsystem executing on the supply chain planning system that initializes a wheel including planning parameters, pre-calculate cycles including netting and factoring, schedules a cycle and produces a rhythm wheel log based on the optimal rhythm wheel design for controlling a production manufacturing process, a rhythm wheel log subsystem executing on the supply chain planning system that creates a sequence optimized material resources planning (MRP) and capacity requirements planning (CRP) production plan based on the wheel log based on the rhythm wheel log for controlling a production manufacturing process and a rhythm wheel monitor subsystem executing on the supply chain planning system to accept data from the rhythm wheel log subsystem to display planning results and key performance indicators to one or more display devices for use by a user, wherein the system permits a single planning step to create a sequence optimized material requirements planning (MRP) and capacity requirements planning log based on the optimal rhythm wheel design and actual net requirements including factoring against existing constraints. The rhythm wheel heuristic subsystem may perform factoring if an actual required total cycle length of a created production schedule exceeds or falls below a predefined maximum or minimum cycle length.

In one aspect, a method for advanced material resource planning and capacity resource planning may comprise creating on a supply chain planning system an optimal rhythm wheel design based on actual production requirements and availability of production resources using at least one sequence optimization algorithm of a plurality of sequence optimization algorithms, selectable by a user and initializing a wheel including planning parameters, pre-calculating cycles including netting and factoring, scheduling a cycle and producing a rhythm wheel log based on the optimal rhythm wheel design for controlling a production manufacturing process. The method may further comprise creating a sequence optimized material resources planning (MRP) and capacity requirements planning (CRP) production plan based on the rhythm wheel log for controlling a production manufacturing process. The method may further comprise outputting key performance indicators to a data warehouse.

The method may further comprise accepting data from the rhythm wheel log subsystem and displaying planning results and key performance indicators to one or more display devices. The at least one sequence optimization algorithm may comprise a plurality of optimization algorithms selected from the group of: sequence optimization, ant colony sequence optimization, simulated annealing sequence optimization and absolute minimum sequence optimization.

### BRIEF DESCRIPTION OF THE DRAWINGS

The accompanying drawings, which are included to provide a further understanding of the disclosure, are incorporated by reference in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1A-1I are examples of various graphical user interfaces related to a Rhythm Wheel Designer, configured according to principles of the disclosure;

FIG. 2A is an example flow chart showing a process for the nearest neighbor adapter for sequence optimization, according to principles of the disclosure;

FIG. 2B is an example flow chart showing a process for ant colony adapter sequence optimizing, according to principles of the disclosure;

FIG. 2C is an example flow chart showing a process for simulated annealing adapter for sequence optimization, according to principles of the disclosure;

FIG. 2D is an example flow chart showing a process for absolute minimum adapter for sequence optimization, according to principles of the disclosure;

FIG. 2E is an example chart showing possible relative runtimes of the various adapters of FIGS. 2A-2D, according to principles of the disclosure;

FIGS. 3A-3C illustrate example parameters that may be entered and/or viewed by a user/planner using the Rhythm Wheel Designer, according to principles of the disclosure;

FIGS. 4A-4G are example illustrations explaining concepts related to factoring, according to principles of the disclosure;

FIGS. 5A and 5B illustrate example performance indicators, according to principles of the disclosure;

FIG. 5C illustrates an example rhythm wheel cycle report, according to principles of the disclosure;

FIG. 5D illustrates example performance indicators, according to principles of the disclosure;

FIG. 5E illustrates example performance indicators in chart form, according to principles of the disclosure;

FIG. 6A illustrates an output of the RWD subsystem with functionality for predicting the impact of a Rhythm Wheel Design on relevant performance indicators, according to principles of the disclosure;

FIG. 6B is an example illustration of activating a Rhythm Wheel design, according to principles of the disclosure;

FIG. 7 is an example illustration showing that in case of no demand for a SKU, the RWH subsystem may skip a SKU according to principles of the disclosure;

FIG. 8 is an example illustration showing factoring, according to principles of the disclosure;

FIG. 9A is an illustration of an example of a CLS/RWL RUN table, according to principles of the disclosure;

FIG. 9B is an example illustration of a CLS/RWL_WHEEL table showing data for each wheel, according to principles of the disclosure;

FIG. 9C is an example illustration of a CLS/RWL_CYCLE table showing data for each cycle within a specific wheel that has been used by the RWH subsystem, according to principles of the disclosure;

FIG. 9D is an example illustration of a CLS/RWL ORDERS table showing data for each order within a specific cycle, according to principles of the disclosure;

FIG. 10A illustrates an example entry screen for the RWM subsystem, configured according to principles of the disclosure;

FIG. 10B is an example illustration of an aggregated view screen, configured according to principles of the disclosure;

FIG. 10C is a close-up view of portions of FIG. 10B;

FIG. 10D shows example calculations of the average KPIs resulting from the RWH subsystem, with corresponding formulas shown in FIG. 10E, according to principles of the disclosure;

FIG. 10F is an example process behavior chart for cycle times, according to principles of the disclosure;

FIG. 10G is an example of Cycle Time Variation, according to principles of the disclosure;

FIG. 10H is an example illustration of how Run To Target (RTT) may track and compare the required replenishment and the actual production quantities in Rhythm Wheel cycles, according to principles of the disclosure;

FIG. 11 is an example illustration of cycle-specific metrics providing an overview of various cycles, according to principles of the disclosure;

FIG. 12 is an example illustration of a detailed cycle view that may include additional detailed information of each cycle, according to principles of the disclosure;

FIG. 13A is an illustration showing an example functional block diagram and process of the Rhythm Wheel Designer (RWD) subsystem and Rhythm Wheel Heuristic (RWH) subsystem 1400, configured according to principles of the disclosure;

FIG. 13B is an illustration showing an example functional block diagram and process of the Rhythm Wheel Log (RWL) subsystem and Rhythm Wheel Monitor (RWM) subsystem; and

FIG. 14 is a generalized example block diagram of a supply chain planning (SCM) system, configured according to principles of the disclosure.

### DETAILED DESCRIPTION OF THE DISCLOSURE

The disclosure and the various features and advantageous details thereof are explained more fully with reference to the non-limiting examples that are described and/or illustrated in the accompanying drawings and detailed in the following description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the principles of the disclosure. The examples used herein are intended merely to facilitate an understanding of ways in which the disclosure may be practiced and to further enable those of skill in the art to practice the features and capabilities of the disclosure. Accordingly, the examples herein should not be construed as limiting the scope of the disclosure. Moreover, it is noted that like reference numerals represent similar parts throughout the several views of the drawings. The features described herein may be performed on a server, a computer and may be performed within a networks environment.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include a computing device, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” when used in a computer network sense, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like. Online refers to and includes activity on a network by connected users of the network. A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

The term “cycle”, as used in this disclosure, means the time which a rhythm wheel needs to produce the designed sequence of products once.

Devices that are in communication with each other need not be in continuous communication with each other, unless expressly specified otherwise. In addition, devices that are in communication with each other may communicate directly or indirectly through one or more intermediaries. Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-transitory media or storage, non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes or altered make-up, a RAM, a PROM, an EPROM, a FLASHEEPROM, any other memory chip or cartridge, or any other tangible medium from which a computer can read. A computer program product having the software for performing the features described herein may include a non-transitory computer-readable medium having the software stored thereon that when read and executed by a computer, performs ten features herein.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The various flow diagrams may also represent a block diagram of software components that when read and executed by an appropriate hardware computing platform that includes a computer may execute the steps described.

The present disclosure provides a system and method for advanced features for material resource planning and capacity resource planning and, more particularly, a system and method for providing high-mix wheels to material resource planning and capacity resource planning, among other features, such as for use in a SAP ERP/SCM system, using integration capacities of these platforms.

The present disclosure includes an integrated approach for Design, Planning and Monitoring of rhythmic production planning by way of:
Rhythm Wheel Designer (RWD)
Rhythm Wheel Heuristic (RWH)
Rhythm Wheel Log (RWL) & Rhythm Wheel Monitor (RWM)
   Thus, supporting the planner with the design of OEE or cost optimized Rhythm Wheel(s) (RW), executing them and measuring the adherence and stock effects in one application.

Also included is an algorithm for automatically factored (adoption of planning result to ensure the adherence of the design constraints. For High-Mix Rhythm Wheels, these are in general the resource capacity, the minimum and maximum Cycle time of a wheel) High-Mix Rhythm Wheel Planning. This algorithm is a new planning approach, simultaneously providing Material Requirement Planning (MRP) and Capacity Requirement Planning (CRP), including various factoring methods and scheduling. Also provided is an ability of the planner to freely combine different factoring methods before the planning is executed to achieve optimal results under the given constraints (Capacity, Demand, Stock, Rhythm Wheel Cycle time) without any manual intervention.

Due to the fact that all calculations may be done as single in-memory calculation, a much higher performance and planning simplification can be achieved compared to the approach of existing Advanced Planning and Scheduling (APS) systems (e.g., factors 5-20 to a comparable standard SAP APO PP/DS planning) where the process is done sequentially (First MRP, then CRP based scheduling and then manual factoring by the planner).

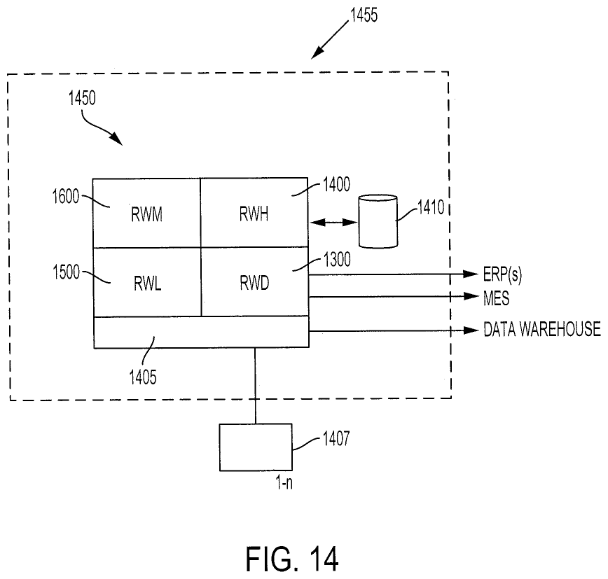

FIG. 14 is a generalized example block diagram of a supply chain planning (SCM) system 1450, configured according to principles of the disclosure. The SCM system 1450 may include any or all types of modules and functionality typically associated with SCM systems, including but not limited to, e.g., human resources module, accounting module, finance module, project management module, and the like. The SCM system 1450 may be,. e.g., a SAP® system, Oracle® system, or similar system. The SCM system 1450 may include a computer processing platform 1405 which may include one or more computers and memory and one or more databases 1410, and may comprise one or more servers. In some embodiments, the SCM system 1450 may be deployed as part of an enterprise resource planning (ERP) system 1455 (e.g. SAP® APO PP/DS on ERP). The SCM system 1450 includes the Rhythm Wheel Designer subsystem 1300, Rhythm Wheel Heuristic subsystem 1400, Rhythm Wheel Log subsystem 1500 and Rhythm Wheel Monitor subsystem 1600, described more fully below. The supply chain planning (SCM) system 1450 may be connected by a network 1530 to other systems such as, e.g. MES 1522, data warehouse 1524, one or more ERP systems, or other systems 1520.

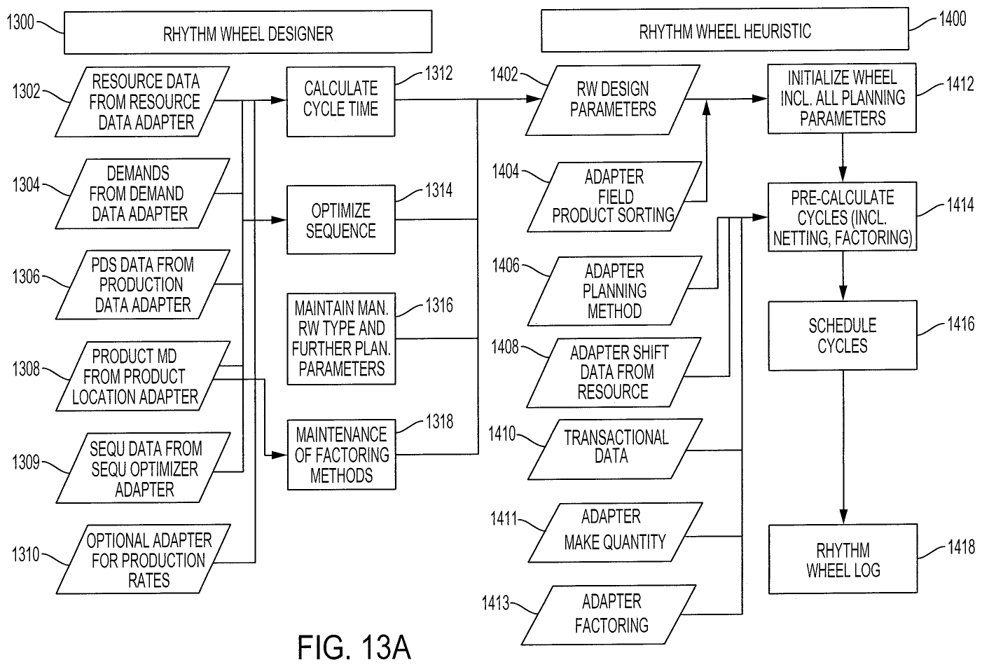

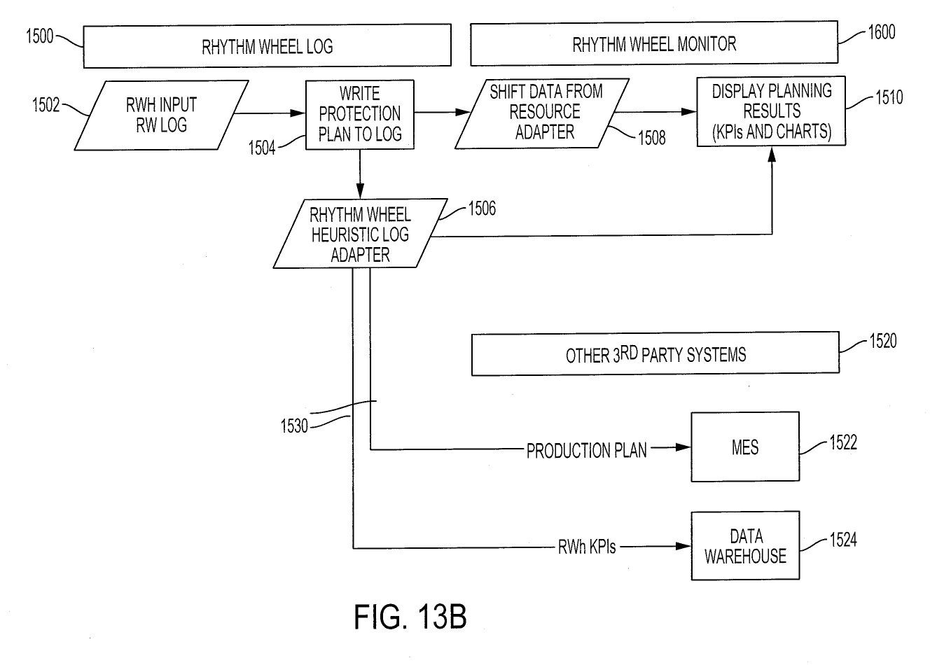

FIG. 13A is an illustration showing an example functional block diagram and process of the Rhythm Wheel Designer (RWD) subsystem 1300 and Rhythm Wheel Heuristic (RWH) subsystem 1400, according to principles of the disclosure. FIGS. 13A and 13B provide an example of a general overview of the process and components employed by the present disclosure, and described more fully below.

The RWD subsystem 1300 (as well as the RWH subsystem 1400, RWL subsystem 1500 and RWM subsystem 1600) may be a SAP® APO add-on. The RWD subsystem 1300 may provide for the maintenance and configuration of Rhythm Wheel designs, and besides Rhythm Wheel scheduling and monitoring, one of the three constituents of the Rhythm Wheel planning landscape.

The RWD subsystem 1300 may enable a holistic process from data upload, identification of the setup optimal product sequence and calculation of cycle length, the maintenance of additional wheel configuration, evaluation of configuration by several KPIs and final adjustments to release for planning as well as the simulation of various based on different design settings. The output of the RWD subsystem 1300 process is an optimized production wheel with ideal product sequence and make-quantities for levelled production, based on the optimization constraints (e.g. OEE, costs). In the medium and long-term horizon, a renewal of parameter settings and configurations (product mix, sequence, quantities) is necessary to incorporate changes of demand patterns (volatility, trends etc.).

Referring to FIG. 13A, RWD subsystem 1300 may accept input or have access to: resource data from a resource adapter 1302; demands from a demand data adapter 1304; production data structure data (which typically may contain information about the production cycle and component assignment for the production of a product) from a production data adapter 1306; product master data (MD) from a product location adapter 1308; sequence data from a sequence optimizer adapter 1309; and an optional adapter for production rates 1310. Generally, an adapter may refer to software objects that allow integration tools to retrieve data efficiently from typically complex, sometimes proprietary stores of information providing the mapping to the target structure.

The RWD subsystem 1300 may have a plurality of modules to calculate cycle times 1312, optimize sequences 1314, maintain Rhythm Wheel types and further planning parameters 1316, and maintain factoring methods 1318. The RWD subsystem 1300 may provide the output, such as the Rhythm Wheel design parameters 1402, from the modules 1312, 1314, 1316, 1318 to the RWH subsystem 1400. The RWH subsystem 1400 may have a plurality of modules, including an initialization module 1412 to initialize a wheel, and including all planning parameters, a product sorting field adapter 1404 (for later visualization), a pre-calculating module 1414 to pre-calculate cycles including netting and factoring, a cycle scheduling module 1416 and a rhythm wheel log module 1418 to produce rhythm wheel log 1502. The pre-calculating module 1414 may accept input or have access to planning method adapter 1406, a make quantity adapter 1411 for the netting algorithm and the factoring adapter 1413, an adapter to shift data from a resource 1408, and transactional data 1410.

FIG. 13B is an illustration showing an example functional block diagram and process of the Rhythm Wheel Log (RWL) subsystem 1500 and Rhythm Wheel Monitor (RWM) subsystem 1600. The RWL subsystem 1500 may accept input or have access to a RWL Log 1502 from the RWH subsystem 1400. RWL subsystem 1500 may include a module 1504 to generate and write a production plan to a log by way of a Rhythm Wheel Heuristic Log adapter 1506. The RWM subsystem 1600 may accept or have access to the RWH Log adapter 1506 and the adapter to shift data from a resource 1508 (which may be adapter 1408) to dynamically display results 1510 on one or more display devices 1407 for use by one or more users. The RWH Log adapter 1506 may make available or provide a production plan or controls to a manufacturing enterprise system (MES) 1522 for production purposes to create products, and may provide RWH key performance indicators (KPIs) to a data warehouse 1524 for subsequent use and retrieval. The RWH Log adapter 1506 may make available or provide a production plan or controls to other third party systems, e.g., for production management and/or control of manufacturing facility and equipment.

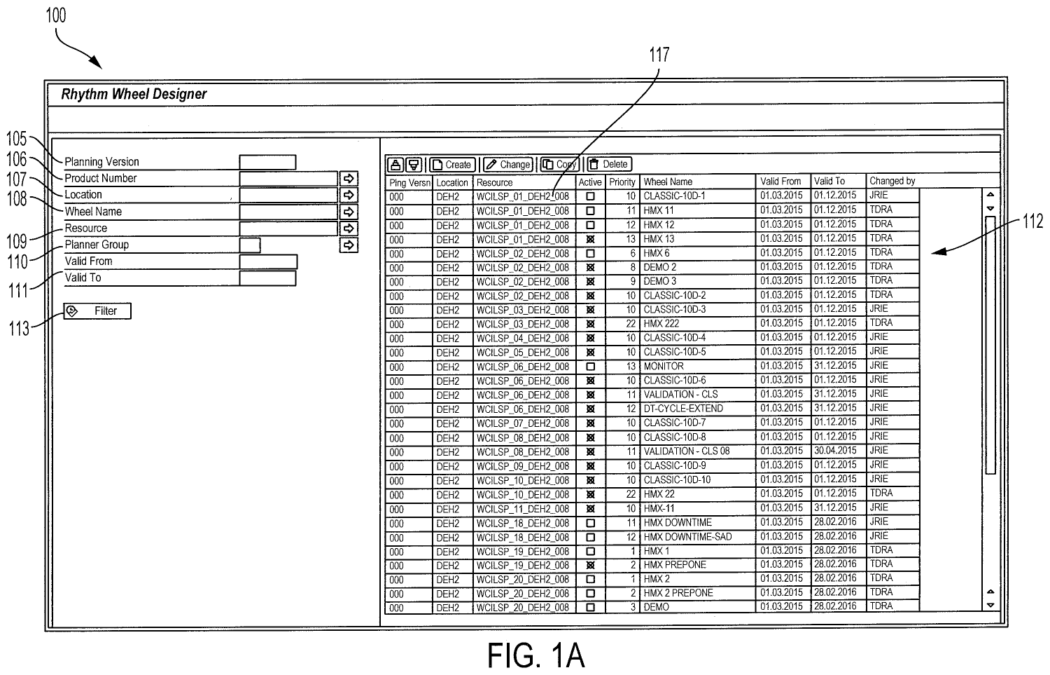

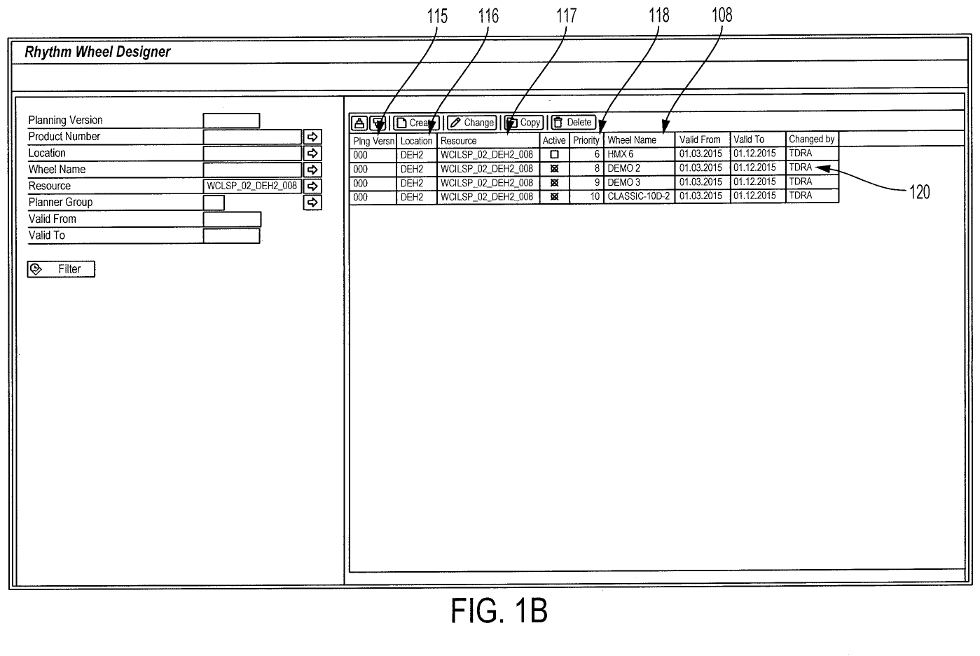

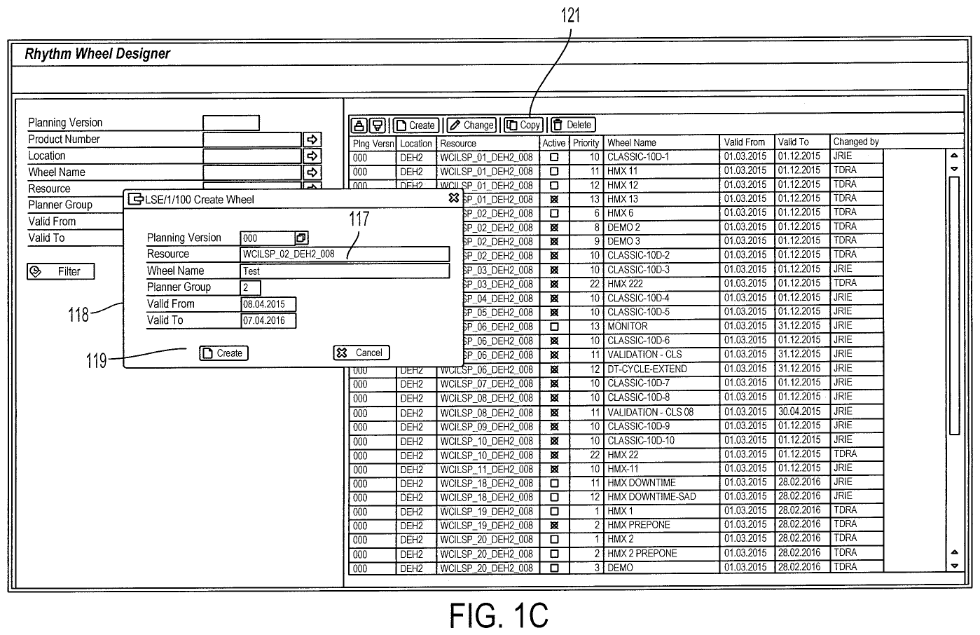

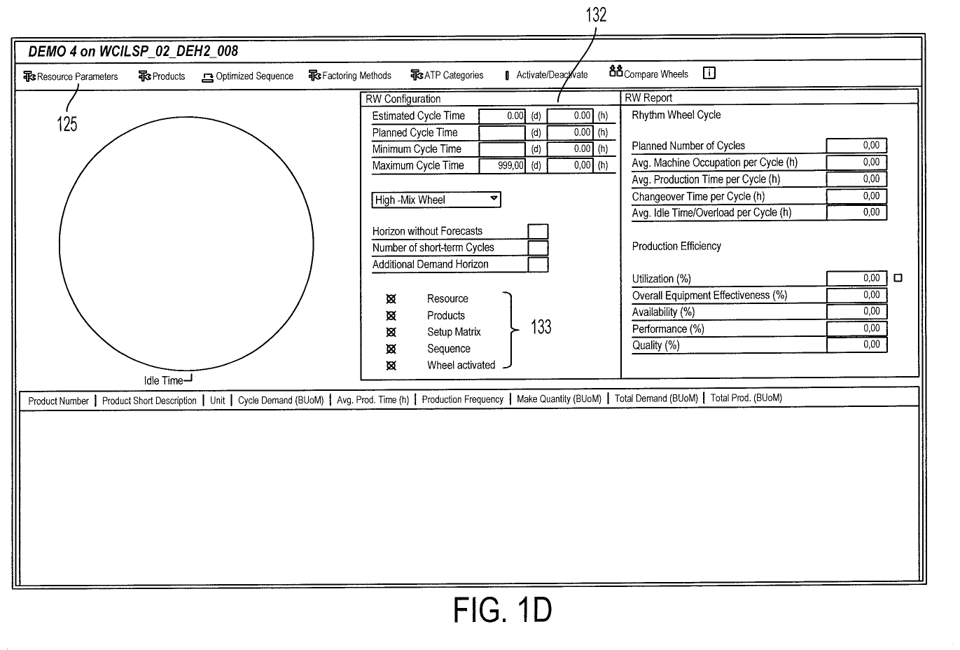

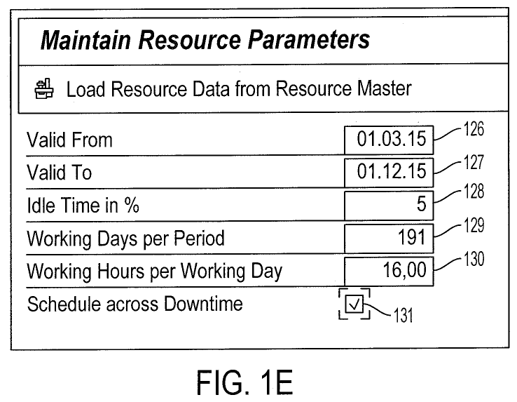

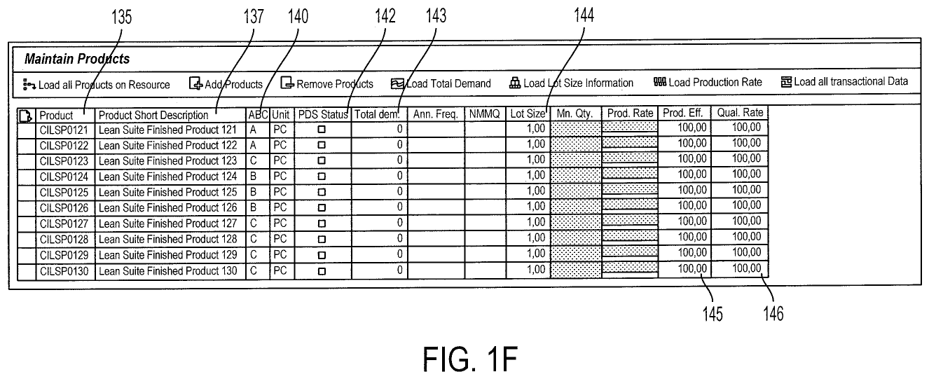

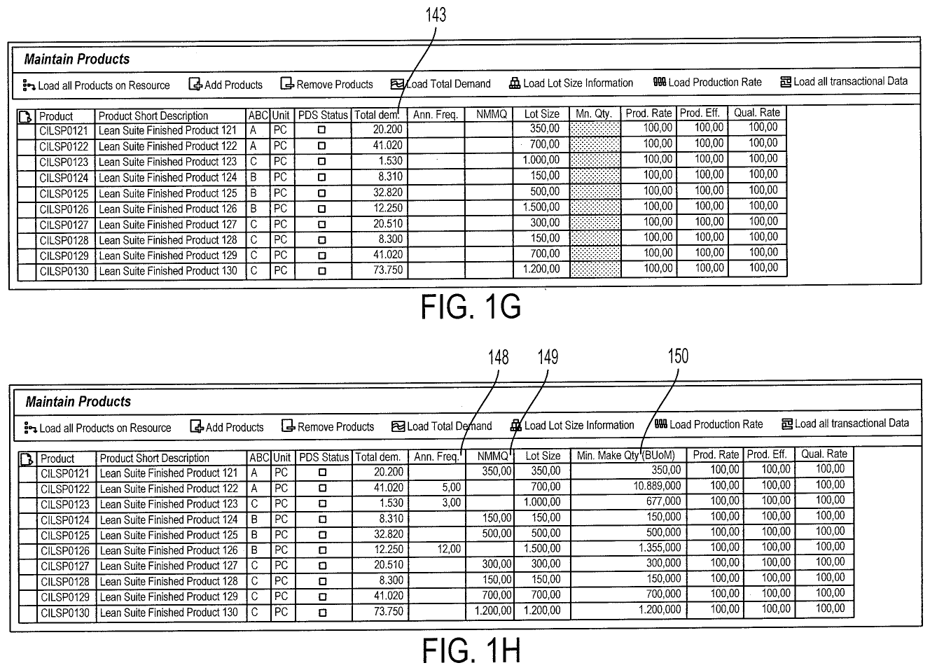

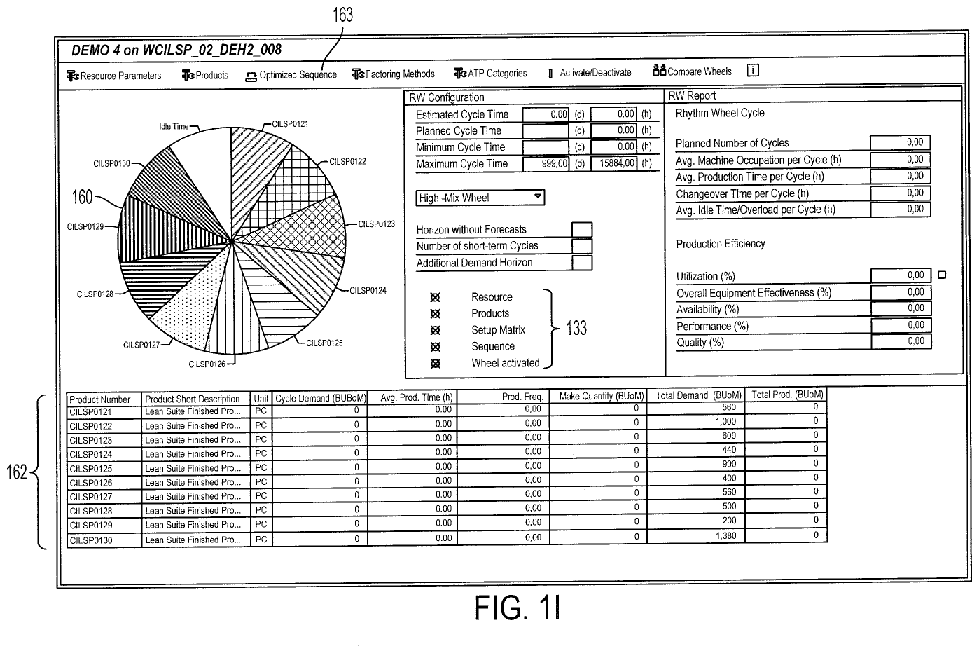

FIG. 1A is an example of a RWD entry screen 100 for use by a user, configured according to principles of the disclosure. FIG. 1B is an example of a RWD display with a specific Resource selection. Within the RWD entry screen 100 all the created wheel designs may be displayed. A table 112 may show the eligible wheels (e.g., displayed in a SAP standard ALV form) with one or more of the following information:
Planning Version 115, column labeled as “Ping Versn.”
Product number 106.
Location 116 and column labeled “Location.”
Resource 117, column labeled as “Resource.”
Activation indicator boxes as denoted in the column labeled “Active.” (Note: Only active RW may be used within the RWH.)
Priority of the wheel 118, as denoted in the column labeled “Priority.” (This value is used, if at a point in time when two active Wheels for the same resource do exist. Then the system will pick the one with the higher priority.)
Wheel Name, column labeled “Wheel Name.”
Valid From, as labeled as “Valid From.”
Valid To, column labeled as “Valid To.”
Wheel last changed by, 120.
   Within the RWD entry screen, the user is able to select a design range by filtering using filter button 113 according to specific selection criteria. Possible selection criteria are:
Planning version 105
Product number which is part of specific wheel design 106
Location 107
Wheel Name 108
Resource 109
Planner Group 110
Valid From and Valid To, together denoted as 111

As shown in FIG. 1C by creating a new wheel design, a user first needs to specify general data of the design illustrated in the create wheel window 118, like planning version 105, relevant resource 117, wheel name 108, priority and/or validity. The wheel name 108 is unique over all created wheel designs. It is not possible to set the same priority for two wheels for the same resource and overlapping validity periods. As soon as this data is specified the wheel design may be created, using a create button 119, and may appear in the table 112. The user can double click on the design in order to complete the design specification, as necessary.

As shown in FIG. 1D, to establish a new RW design based on the data of an already existing Wheel, the user may be able to copy a RW design, using copy selection 121 (FIG. 1C). This copy functionality creates an exact copy. The user may need to change the general wheel data, at least the wheel name 108. All data copied in the new wheel can be changed in a later step. In order to complete and activate the wheel design resource and product data needs to be provided in order to calculate the cycle time and the optimal production sequence. Therefore user follows the steps which are indicated by traffic lights 133 in the center of the screen.

Attributes from the Advanced Planner and Optimizer (APO) resource master of the SCM system may be used in order to calculate the cycle time. By clicking on the “Resource Parameters” 125 button the user may enter the resource screen of the RWD, shown in FIG. 1E. The RWD subsystem 1300 allows loading the following relevant data from the APO resource master data based on the validity dates of the wheel:
Working days per period 129
Working hours per working day 130
   For simulation purpose the fields can also be maintained manually without loading the data from the resource master data. Additional data can be maintained if needed, such as:
Valid From 126.
Valid To 127.
Idle time (in %) 128: the available time on the resource will be reduced accordingly.
“Schedule across downtimes” checkbox 131: indicates whether the RWH subsystem 1400 should schedule across downtimes or not. In contrast, SAP standard behavior never schedules across downtimes.
   As soon as the resource master data is maintained and the user goes back to the overview screen, the traffic light “Resource” in the traffic light area 133 is marked in green. The green, red, yellow indicators used herein in reference to the traffic light 133 are examples; however, other types of indicators may be implemented.

The user can load all products on the selected resource automatically. Due to the fact that not every product needs to be considered on one production asset, the user is able to add or remove products included in the RW configuration 132. For the selected products, the Product Number 135, Product Description 137, and ABC Classification 140 may be displayed as shown in FIGS. 1F-1H. Additionally, a traffic light 133 will give information on the production data structure (PDS) status 142 for the selected period:
Green Status: at least one PDS exists which is valid for the whole wheel horizon.
Yellow Status: during the whole wheel horizon at any time at least one valid PDS exists.
Red Status: there is at least one time period where no valid PDS exists.

If at least one product exists with a red PDS traffic light, the wheel design cannot be completed. The following rule selects the PDS for the Wheel design:
RWD checks, if at least one PDS is valid for the whole Wheel horizon. If yes, the RWD takes the PDS with the highest priority into account for further calculation.
If no, PDS is valid for the whole Wheel horizon, and RWD checks for the PDS valid at the beginning of the wheel. It will take the one with the highest priority into account and assume the validity for the whole horizon for further calculation.
If no, PDS is valid, values cannot be calculated, and the wheel design cannot be completed.

The following data can be loaded from APO automatically on request but can also be adjusted manually:
Total Demand 143 in the wheel period—any kind of demand category.
Minimum lot size 144 or fixed lot size from product master.
Production rate from PDS.
Production efficiency 145 (in BUoM/h) set by default to 100%.
   This can be adjusted manually, or
   Updated by an interface from an IVIES system (e.g., 1522 FIG. 13B)
Quality rate 146 (in %) set by default at 100% but can be adjusted manually.

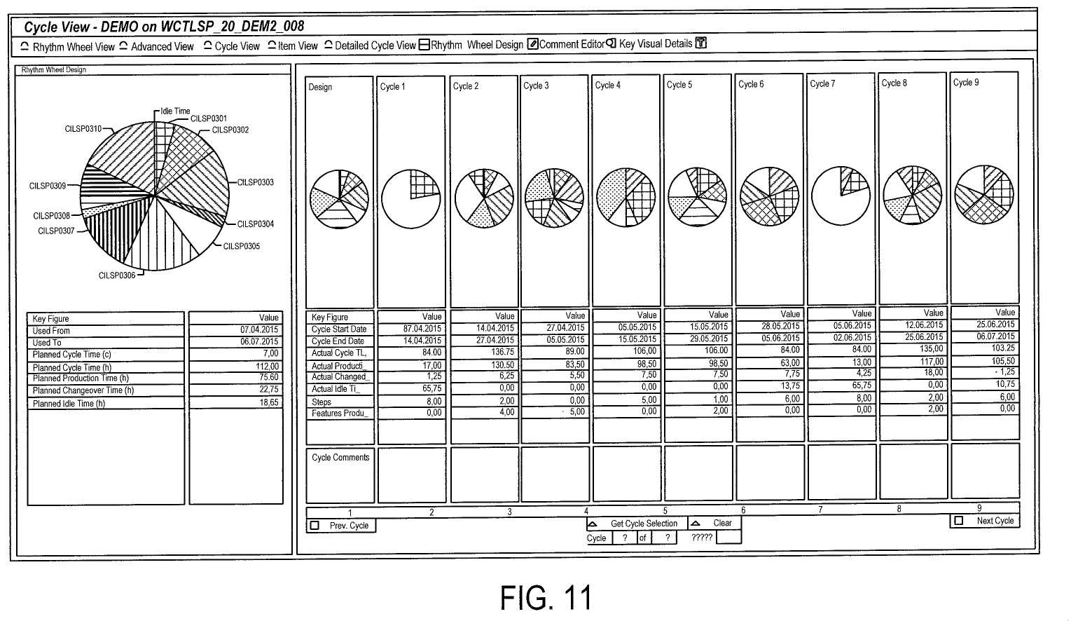

During the design of a Wheel, the planner has to maintain per product either an annual frequency 148 of production or a manual minimum make quantity (MMMQ) 149 which is an economical lot size to let the system calculate a minimum make quantity (MMQ) 150. The MMQ is not to mistake with the minimum lot size and is taken into account by the RWD for the cycle time calculation as well as by the RWH subsystem 1400. As soon as the product master and transactional data is maintained and the user goes back to the overview screen (FIG. 11) the traffic light 133 “Products” is marked in green. The traffic light 133 “Setup Matrix” is also marked in green if all the setup relevant master data are maintained in the resource and product master. The pie chart display 160 may be updated to reflect status of products being maintained as shown in table 162.

On the basis of the data defined in the maintenance of resources and products (e.g., FIG. 11), the RWD subsystem 1300 is able to calculate the optimal sequence automatically by clicking on “Optimize sequence” button 163. Therefore, the LEAN Suite offers four adapters, the Nearest Neighbor Adapter, the Simulated Annealing Adapter, the Absolute Minimum Adapter and the Ant Colony System Adapter which can be chosen by the planner in the customizing cockpit of the LEAN Suite. The adapter requires the following input:
Table with material numbers
Setup matrix, which is created on basis of material number combinations

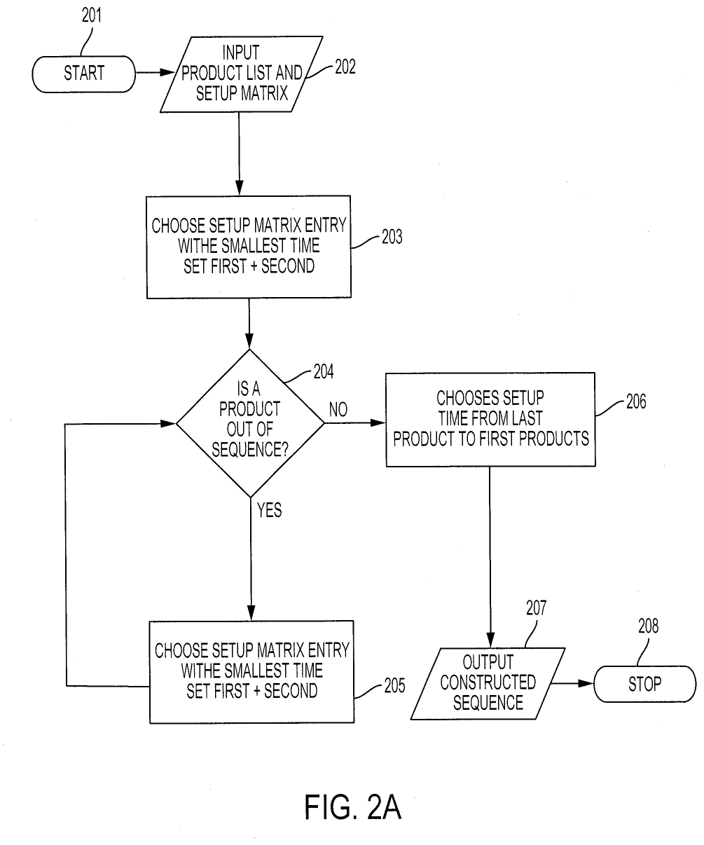

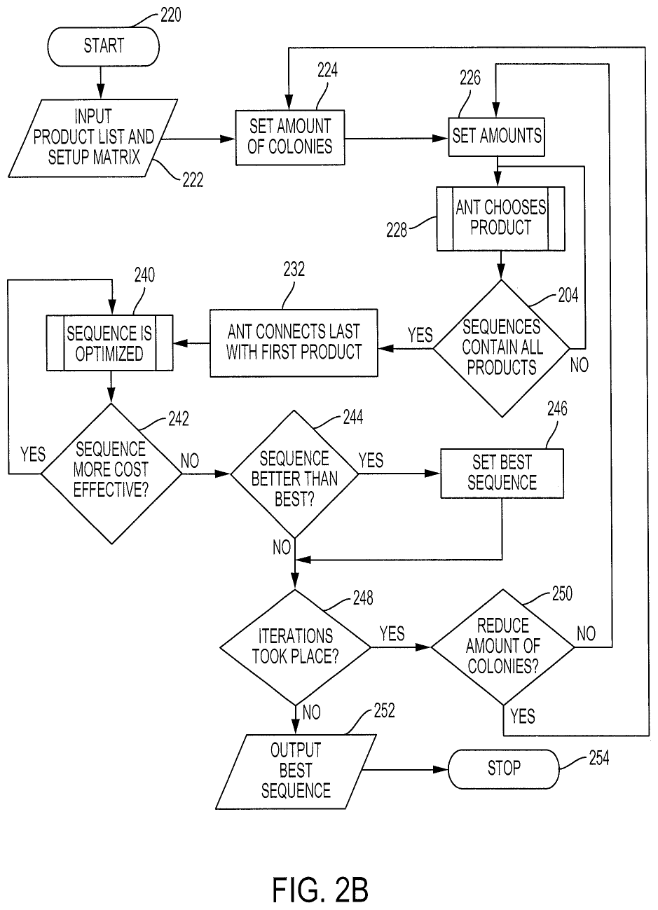

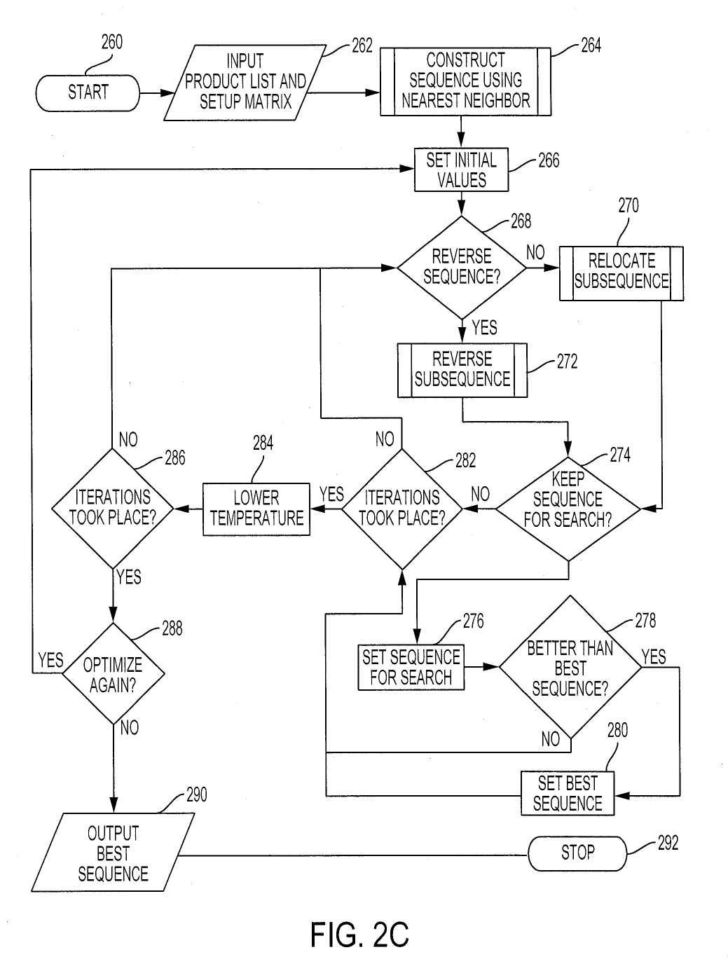

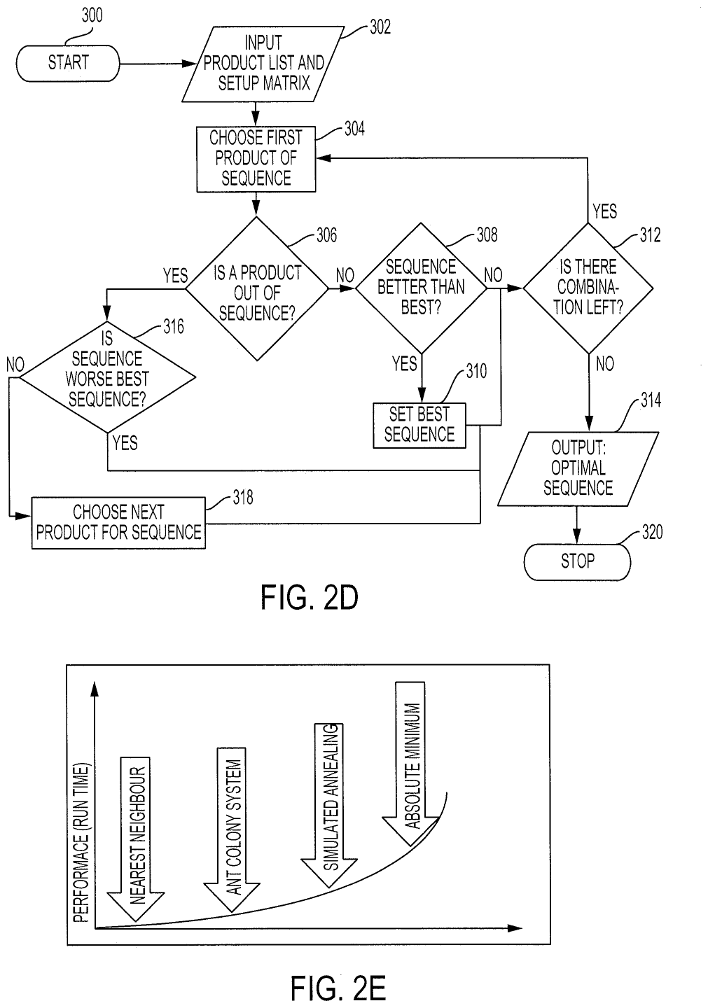

As shown in FIG. 2A, the nearest neighbor adapter can be used for sequence optimization problems with complete setup matrix, but the method is on occasion unreliable so other adapters should be used as well. The nearest neighbor heuristic constructs a sequence which will be the output. Referring to FIG. 2A, the process begins at 201. At step 202, a product list may be input and a matrix may be set-up. At step 203, choose the set-up matrix entry with the smallest time set, First+Second. At step 204, a check is made to determine if a product is out of sequence. If so, then at step 205 a setup matrix entry is chosen with the smallest time set, First+Second. If, however, at step 204, there is no product out of sequence, then at step 206, setup time is chosen from the last product to first products. At step 207, the sequence is outputted for subsequent use. At step 208, the process ends.

The ant colony adapter can be used for all kinds of sequence optimizing problems. It is recommended to use this adapter especially for material combinations when some materials can be produced after others. As the ant colony algorithm is a constructive heuristic, the probability of finding a producible sequence is higher than, for example, as nearest neighbor and simulated annealing. The ant colony heuristic outputs the best sequence it calculated.

As shown in FIG. 2B which starts at step 220, at step 222 a product list and setup matrix may be inputted. At step 224, the number of colonies may be set. At step 226, the amount is set. At step 228, the ANT chooses a product. At step 204, a check is made to determine if the sequence contains all products. If not, then the process continues at step 228. If the sequence contains all products, then at step 232, the ANT connects the last product with the first product. At step 240, the sequence is subject to an optimizing pass. At step 242, a check is made to determine if the sequence is more cost effective than a previous optimization pass. If yes, then the process continues at step 240; if no, then at step 244 a check is made to determine if the current sequence is better than the current best sequence. If yes, then at step 246 the current sequence is set to be the current “best sequence;” if no, then a check is made at step 248 to determine whether an iteration has taken place. If not, then the current sequence is output as the best sequence, and the process ends at step 254. If, however, iterations have taken place at step 248, then at step 250, a check is made to determine if the amount of colonies has been reduced. If not, the process continues at step 226; if yes, then the process continues at step 224.

The simulated annealing adapter can be used for sequence optimization problems with complete setup matrix. Simulated annealing uses nearest neighbor heuristic to construct the initial sequence. Therefore, it is possible that the heuristic lacks finding sequences when using incomplete setup matrices. As Simulated Annealing works with many sequences, its output is the best sequence that was worked with.

As shown in FIG. 2C which starts at step 260, at step 262, a product list may be input and a matrix may be set-up. At step 264, a sequence may be constructed using the nearest neighbor technique (e.g., as shown in FIG. 2A). At step 266, initial values may be set. At step 268, a check is made to determine if the sequence is to be reversed. If not, at step 270 the sequence may be relocated. If yes, then at step 272 the sequence may be reversed. At step 274, a check is made if the sequence should be kept for a search. If no, the processing continues at step 282; if yes, then at step 276 the sequence is used for a search. At step 278, a check is made to determine if the current sequence is better than the current best sequence. If no, the processing continues at step 282; if yes, then at step 280 the sequence is set to a new best sequence, and processing continues at step 282. At step 282, a check is made to determine if iterations have taken place. If no, then processing continues at step 268; if yes, then at step 284 the “temperature” may be lowered. At step 286, a check is made to determine if iterations have taken place, if no, then processing continues at step 268; if yes, then at step 288 a check is made to determine if optimization should be performed again. If yes, then processing continues at step 266; if no, then at step 290 a best sequence may be output. The process ends at step 292.

The absolute minimum adapter should be used if the amount of regarded materials is lower or equal to 10 as it delivers the minimal solution. The absolute minimum algorithm calculates the minimum sequence.

As shown in FIG. 2D which starts at step 300, at step 302 a product list may be input and a matrix may be set-up. A first product of the sequence may be chosen at step 304. At step 306, a check is made to determine if a product is out of sequence. If yes, then at step 316 a check is made to determine if a worse best sequence; if yes, processing continues at step 312; if not, then at step 318, the next production sequence may be chosen, and processing continues at step 312. If at step 306 the product is not out of sequence, then at step 308 a check is made to determine if the sequence is better than the current best sequence. If yes, then at step 310 the sequence is then set to the current best sequence, and processing continues at step 312. At step 312, a check is made to determine if there are any combinations left. If yes, then processing continues at step 304; if not, then at step 314, the optimal sequence is output and the process may end at step 320.

As shown in FIG. 2E, the runtimes of the various adapters may vary, however, the user is able to change the sequence of products via drag and drop controls. Key visual and several RW key figures on the main screen may be adapted automatically.

Based on all the maintained product and resource data the RWD subsystem 1300 is able to calculate the so-called estimated cycle time. The cycle time calculation is an approximation procedure. And may be based on the reference demand of the products allocated on the wheel, including the dummy product for non RW products. With regard to estimated production times and the working time available, the campaign size is minimized in order to level production as much as possible.

Estimated cycle time calculation:

1. Iteration
a) Calculation of the total available time for production and changeover on relevant resource specified in resource master screen of RWD; Ex.: 756 h total available time.
b) Calculation of total production time based on total demand per product and production rate specified in product master of RWD; Ex.: 486 h total production time.
c) Calculation of total changeover time by calculating the difference of total available time and total production time. Ex.: 756 h−486 h=270 h.
d) Calculation of changeover time per cycle. The changeover time is taken from the setup matrix and added up according to the optimized production sequence specified in the RWD. Ex.: 45 h/cycle.
e) Calculation of number of cycles that can be performed in the whole horizon. The total changeover time is divided by the changeover time for one cycle. Ex.: 270 h/45 h=6 cycles.
f) Calculation of estimated cycle time (n. Iteration). The total available time is divided by the number of cycles. Ex.: 756 h/6=126 h.

2. Iteration
g) Calculation of the cycle demand per product. Divide the total demand per product by the number of cycle of previous iteration n−1.
h) Calculation of production frequency with consideration of the MMQ. If the cycle demand of a product is lower than its MMQ then the production frequency is higher than 1 (production frequency 1=the product is produced every cycle, production frequency 2=the product is produced every second cycle, etc.) Production Frequency=Cycle demand/MMQ.
i) Re-calculation of changeover time. In consideration of the production frequency the changeover time per product is re-calculated changeover time per product/production frequency=changeover time per product (iteration n−1).
j) Calculation of number of cycles that can be performed in the whole horizon. The total changeover time is divided by the changeover time per cycle (2. 'ter.).
k) Calculation of estimated cycle time (2. Iteration). The total available time is divided by the number of cycles.
l) Increase Iteration ID. Iteration n=n+1 and continue with step g). Doing this iteratively means that the cycle time converges. If the cycle time runs out of the minimum or maximum cycle time, then the cycle time is set to the boundary.

Definition of planned cycle time and cycle time boundaries:

Based on the estimated cycle time the user defines a planned cycle time as well as cycle time boundaries. The planned cycle time should not be higher than the estimated cycle time.

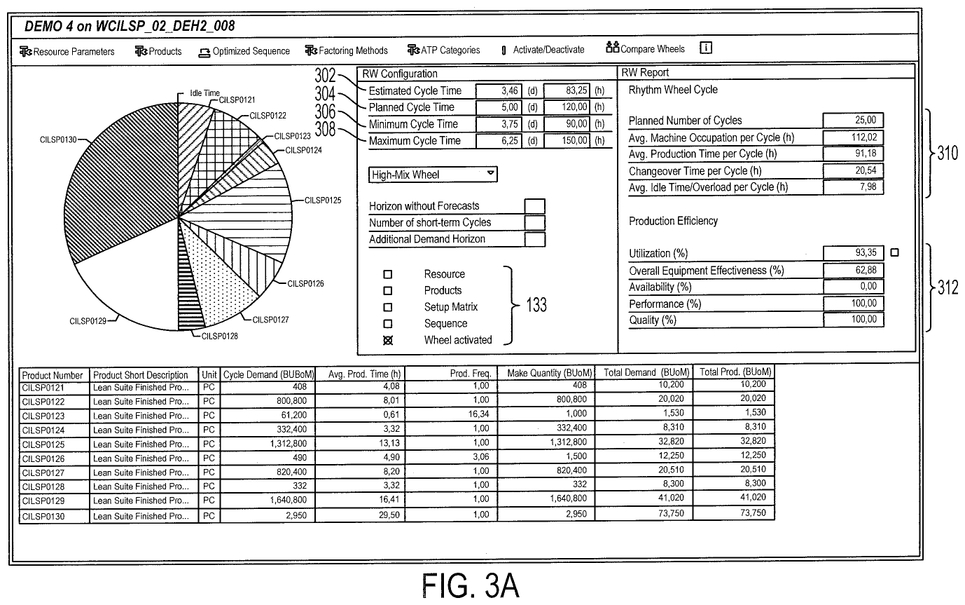

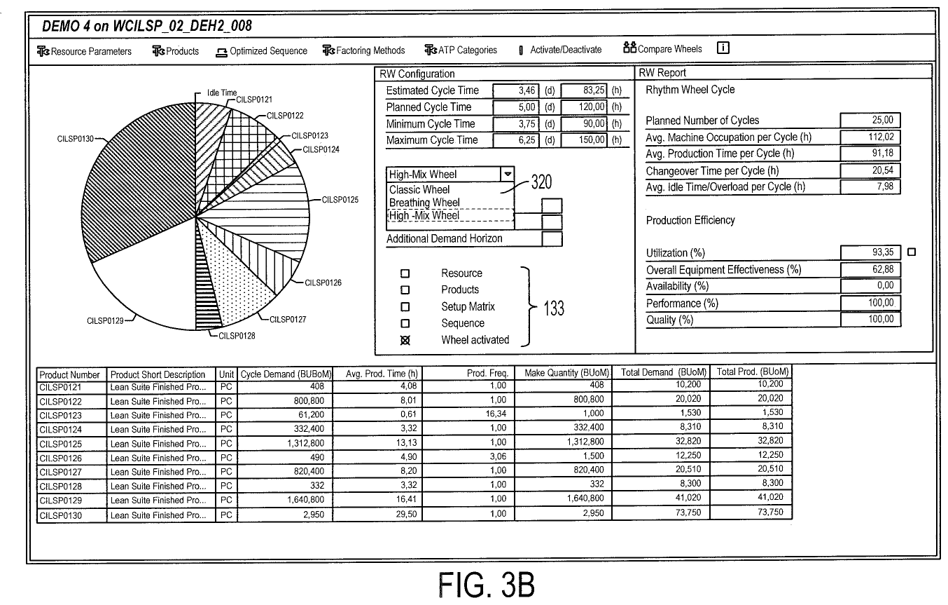

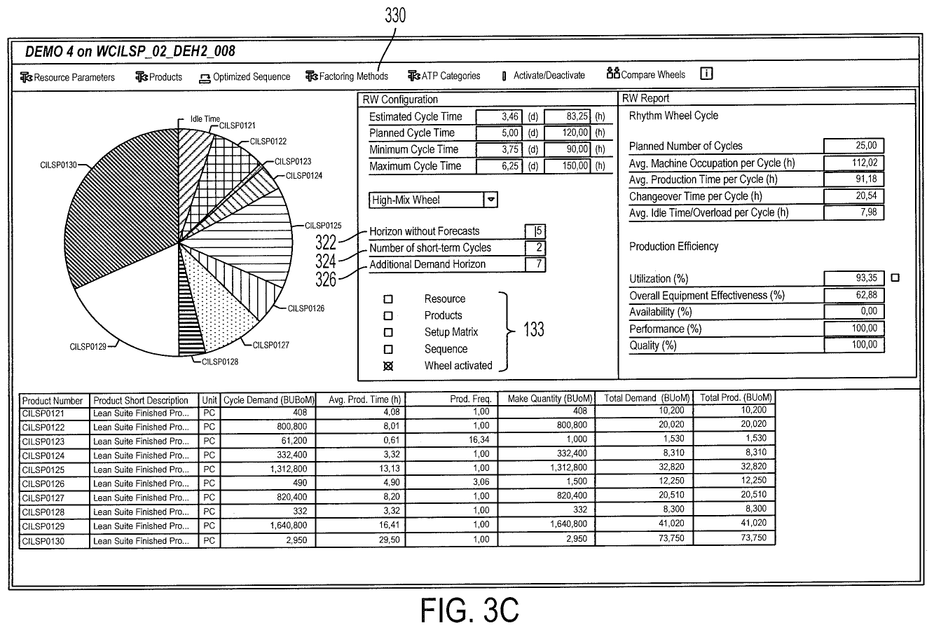

As soon as the planned cycle time is maintained, the RWD subsystem 1300 may propose a minimum cycle time of 75% of the planned cycle time and a maximum cycle time of 125%. The user may need to review these figures and update them manually if required. The Rhythm Wheel heuristic subsystem 1400 may take these figures into account when scheduling the Orders. The cycle time boundaries may be exceeded. FIG. 3A illustrates parameters that may be entered by a user/planner including planned cycle time 304, minimum cycle time 306, and maximum cycle time 308. Estimated cycle time 302 may be calculated as working days/# cycles.

The Rhythm Wheel Designer subsystem 1300 may support three Rhythm Wheel types:
Classic Rhythm Wheel: Fixed quantities (minimum make quantity) of the products are produced. Every product is produced every cycle.
Breathing Rhythm Wheel: Varying quantities according to demand signals of the products are produced. Every product is produced every cycle.
High-Mix Rhythm Wheel: Varying quantities according to demand signals of the products are produced. Products can be skipped within a cycle if there is no demand signal or if the minimum make quantity is not reached.

For a homogenous product mix with rather constant demand, every product is scheduled every cycle. The Classic Rhythm Wheel produces fixed quantities according to a fixed schedule. The Breathing Rhythm Wheel produces fixed quantities according to a fixed schedule. For a high mix portfolio, the High-Mix Rhythm Wheel may be favorable to define different production rhythms. For example, low volume products are not scheduled every cycle to avoid high set-up times compared with the effective production time. The average cycle may be shortened which saves cycle stock for high. FIG. 3b illustrates options 320 for a planner to select Rhythm Wheel types.

As shown in FIG. 3C, the planner can maintain additional parameters which do not influence the cycle time or the production sequence but which are taken into account by the RWH subsystem 1400. Horizon without Forecast 322: during this horizon (in working days) the RWH subsystem 1400 will not take forecasts into account but only real demand data like sales orders. Number of short term cycles 324: identifies the number of cycles in which the RWH subsystem 1400 may allow shifting make-to-order or fixed orders forward. Additional demand horizon 326: The RWH subsystem 1400 may take all requirements for one product into account for the horizon of one planned cycle time. If an additional demand horizon is maintained, the RWH subsystem 1400 may extend its demand horizon by the number of days specified.

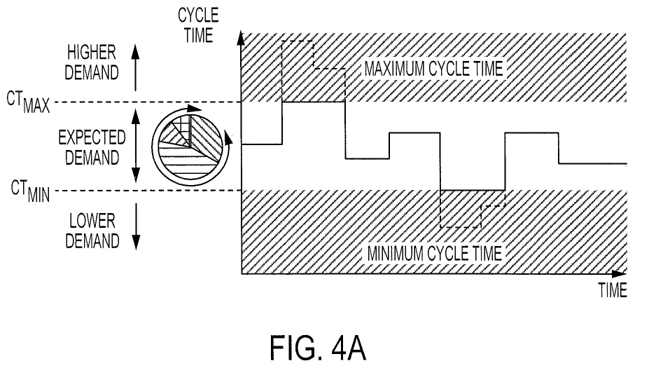

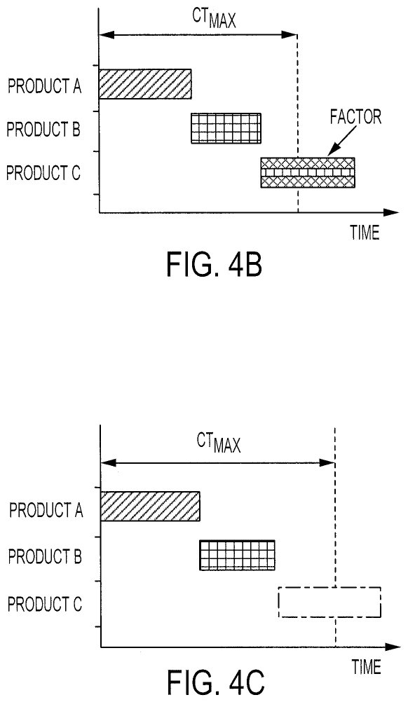

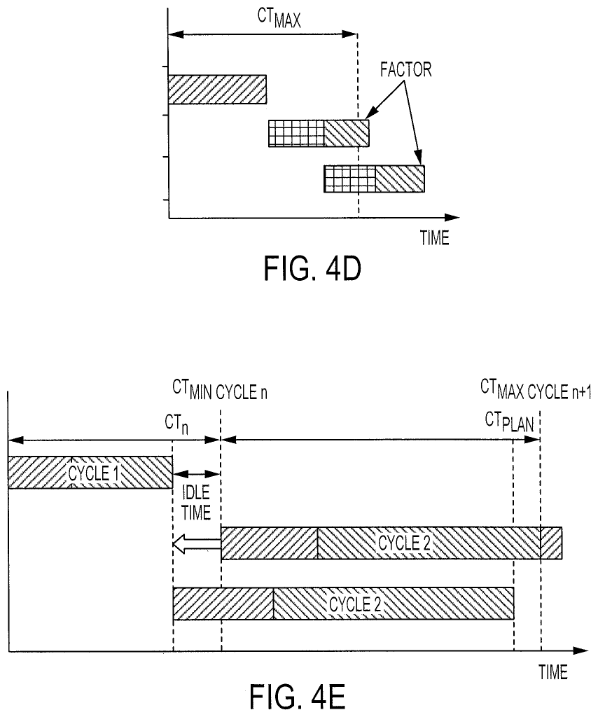

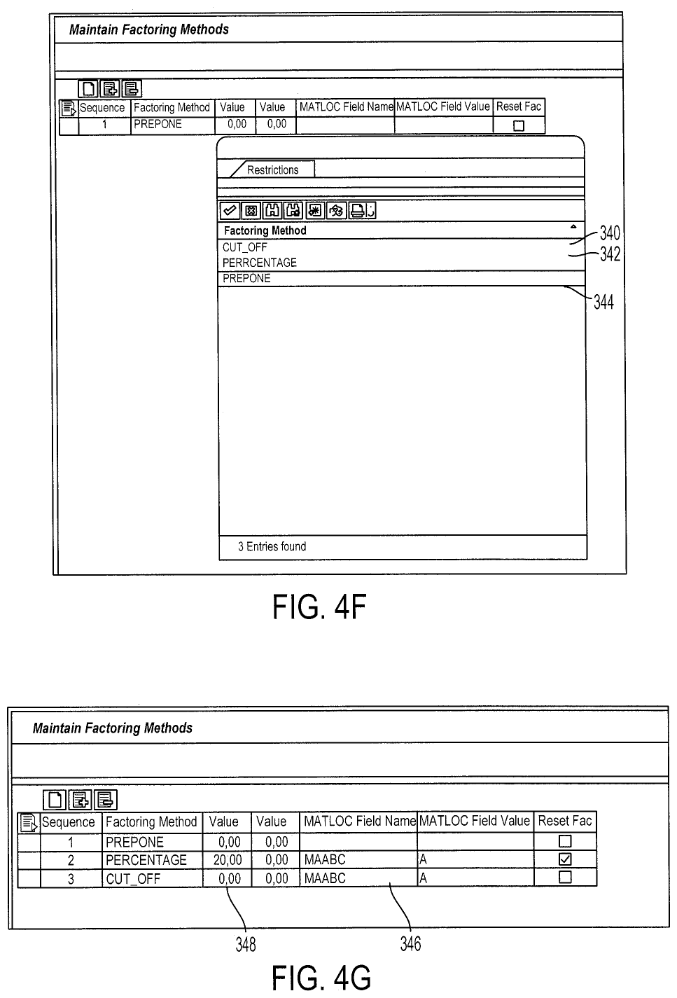

As illustrated in FIG. 4A, factoring may be necessary if the actual required total cycle length of the created production schedule exceeds or falls below the predefined maximum or minimum cycle length. The user can click on the “Factoring Methods” 330 (FIG. 3C).

Minimum factoring is required if the actual cycle time falls below the minimum cycle time boundary. If the cycle time of a wheel is below the minimum cycle time, the RWH subsystem 1400 may automatically postpone the next cycle until the minimum cycle time requirement is met. This may result in idle time on the resource. The idle time can be used for maintenance, training, continuous improvement or other activities that are frequently required.

Maximum factoring refers to the shortening of the Rhythm Wheel cycle time. There exist various methods for reducing the cycle time, which can be combined with each other. Make to Order (MTO) products and fixed orders must be excluded from factoring. In case of MTO products or fixed orders, the production quantity and due dates must coincide with the order quantity and date to deliver on time in full (OTIF).

Maximum factoring—Default factoring (De-allocated): as illustrated in FIG. 4B, the default factoring method is always active and is applied if a cycle violates the cycle time boundaries and either no other factoring methods were assigned to the wheel or they did not result in a full attainment of the boundaries. The default methods may be executed in the case that no further factoring method is assigned to the resource or customized factoring methods executed in the pre-calculation have not succeeded in shortening the cycle time below the maximum cycle time or the minimum cycle time is violated. The de-allocate orders factoring keeps all scheduled orders but may de-allocate the ones that do not fit into the current production cycle. The system may treat these orders as receipts and they remain visible for the production planner in the planning board. The planner can then decide manually where the planned orders can alternatively be placed.

As illustrated in FIG. 4C, beside the default factoring method, additional factoring methods can be maintained. Maximum factoring—Cut-off factoring 340 (FIG. 4F): during the cut-off factoring orders are removed from the pre-calculation and will not be scheduled. This factoring method can be limited to specific materials by specifying a database field 346 (e.g. ABC indicator in table /SAPAPO/MATLOC) and a value 348 for it, as shown in FIG. 4G.

As illustrated in FIG. 4C, Maximum factoring—Proportional factoring: when using proportional factoring, all calculated make quantities are factored proportionally. The user can maintain the proportional factor in percentage 342 (e.g., 80%) that is applied to each order to reduce the overall cycle time. This may reduce the receipt quantity of the orders unless the lot size profile (e.g., minimum lot size) does not allow this. For products with several lots in a cycle, the factoring is done lot wise. This factoring method can be limited to specific materials by specifying a database field 346 (e.g. ABC indicator in table /SAPAPO/MATLOC) and a value 348 for it.

As illustrated in FIG. 4D, preponed factoring uses the idle time of the predecessor cycle in the case it was factored against minimum cycle time. Hence, the heuristic can close the gap by preponing the current cycle. Prepone 344 method is reflected also in FIG. 4F.

When creating a Rhythm Wheel, various ATP categories can be defined which are not taken into account by the Rhythm Wheel heuristic at all. The heuristic does not schedule any planned orders for these categories since they are not considered in the netting. Furthermore, it is possible to maintain ATP categories which are considered as MTO orders by the heuristic.

Rhythm Wheel Report KPIs: the RWD subsystem 1300 may be equipped with functionality for predicting the impact of a Rhythm Wheel design on relevant performance indicators. This functionality provides important support for planners seeking the right pre-configuration of their rhythm-managed production assets.

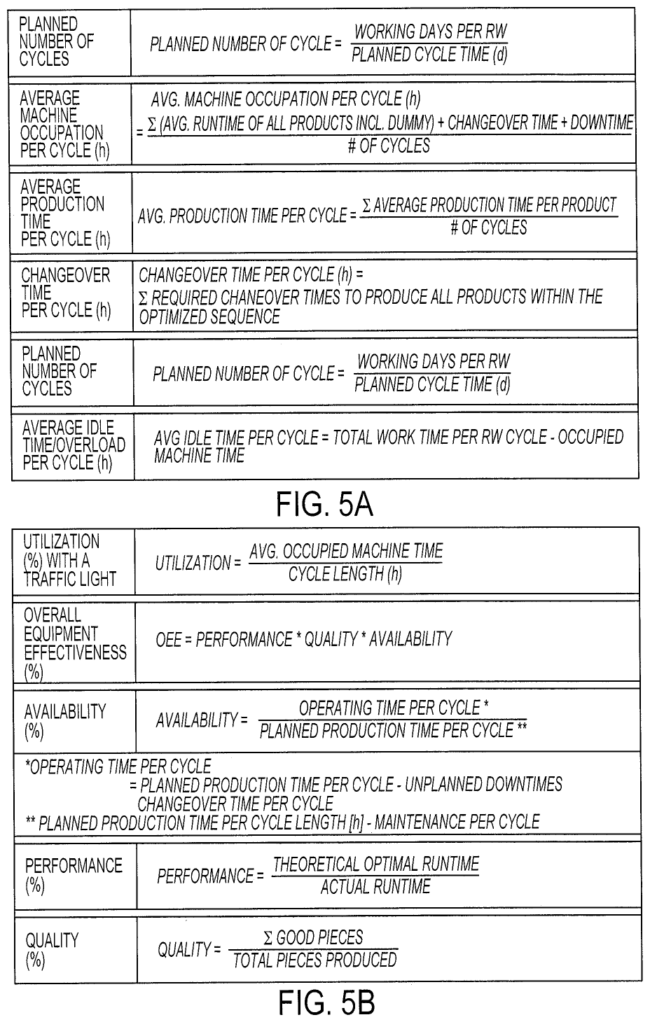

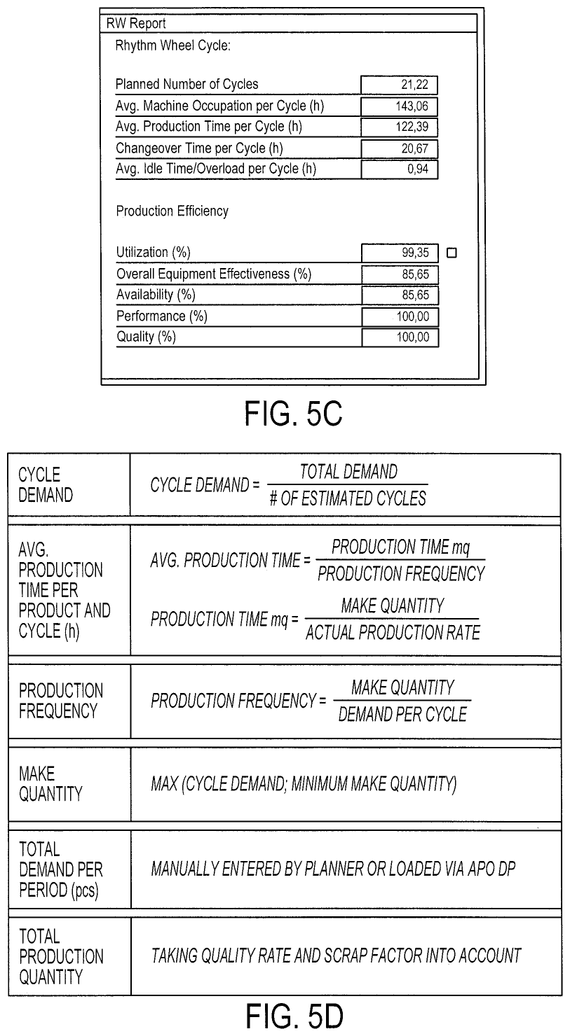

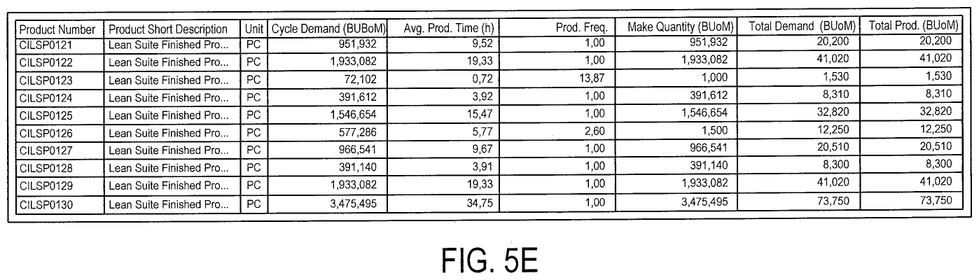

Within a Rhythm Wheel Report as illustrated in FIG. 5C, the main key performance indicators (KPIs) are subdivided into two main categories: Rhythm Wheel Cycle and Production Efficiency. Additionally, the RWD subsystem 1300 offers a number of performance indicators regarding each considered product as illustrated in FIG. 5A and 5B: FIG. 5A illustrates RW Cycle indicators and FIG. 5B illustrates production efficiency indicators. Performance indicators regarding each product are also provided by the RWD subsystem 1300 as illustrated in FIGS. 5D and 5E.

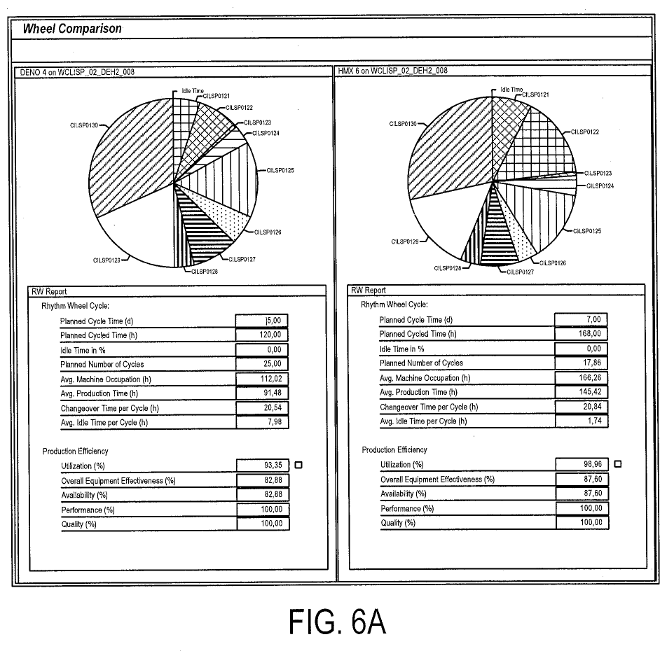

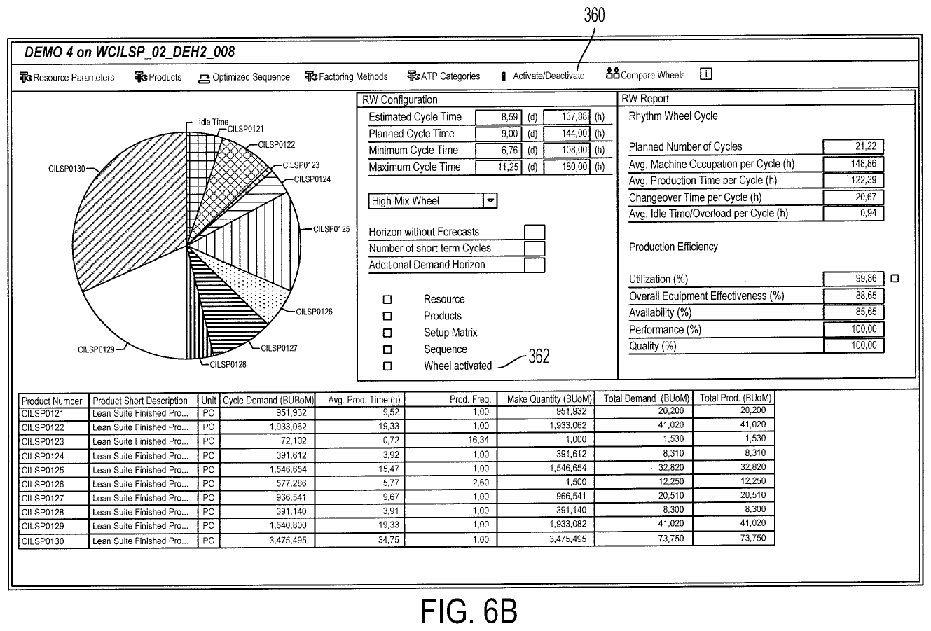

As illustrated in FIG. 6A, and as mentioned previously, the RWD subsystem 1300 may be equipped with functionality for predicting the impact of a Rhythm Wheel design on relevant performance indicators such as overall equipment efficiency and the estimated changeover time per Rhythm Wheel cycle. This functionality provides important support for planners seeking the right pre-configuration of their rhythm-managed production assets. FIG. 6 compares two different wheels, one on the left (DEMO 4) and one the right (HMX 6).

FIG. 6B illustrates activation of a RW design. Once all relevant fields have been maintained and all traffic lights are marked in green, the user can activate the Rhythm Wheel via Activation/Deactivation 360. The Wheel Activated 362 may change color. When changing parameters or master data of an active wheel, it may be deactivated automatically and may have to be activated again. Only activated Rhythm Wheel designs can be selected and used by the RWH subsystem 1400.

Rhythm Wheel Heuristic

Based on a Rhythm Wheel design created in the RWD subsystem 1300, the SAP APO system, or similar system, can schedule orders in the optimal sequence and quantity. The latest demand information from the supply chain network may be used for this automated activity. In case of no demand or demand lower than the minimum make quantity for a Stock Keeping Unit (SKU), the RWH subsystem 1400 may skip this SKU during the current cycle and will take it into account during cycle, if there is relevant demand available.

To prevent cycles of the Rhythm Wheel from becoming continuously shorter (or longer), factoring methods (explained more below) are typically used. The following factoring methods are always active:
Minimum cycle time
Maximum cycle time de-allocate orders

For the creation of the optimal production schedule, the RWH subsystem 1400 may take the following main parameters and characteristics into account:
Input:
   Designed RW (Output from RW Designer), including:
      Validity
      Location products
      Inventory replenishment level
      Planned/minimum/maximum cycle time
      Minimum make quantity
      RW Sequence
      Optional:
         X-line
         Number of short-term cycles
   Material master data
      Product Data Structure (PDS) [Bill of Materials+Routing]
      Lot size profile
      Requirements profile
      Base unit of measure
      Planning method
   Transactional data
      Current receipts
      Current requirements/demands
      Stock
   Optional: APO SNP Time series for time dependent planning parameters, e.g., IRL
      The RWH subsystem 1400 may apply the input parameter in order to achieve the corresponding output:
Output:
   Finite production plan
      Is directly saved into, e.g., SAP APO—PP/DS
      Is directly saved into the RWL 1418
         The production plan may be saved in RWL 1418. This data is used by the RWM subsystem 1600 to control the performance of the RW and to initiate necessary adjustments such as changing the capacity profile or adjusting the RW cycle time in the RWD subsystem 1300.
         Furthermore, this data can be sent via the Rhythm Wheel Log Adapter 1506 to other systems such as:
MES System (Production plan)
Data Warehouse System (RW KPIs, RW History)

The Rhythm Wheel Heuristic planning horizon is divided into the short-term horizon and long-term horizon. In these horizons the calculation order-quantities and handling of exceptions may be treated differently. In the short-term horizon, the concept typically covers real consumption only. This means produced material quantities always refer to a specified Replenishment Level, the IRL (Inventory Replenishment Level), and not to a forecast. But for an accurate procurement, already in the short term horizon, a forecast share is considered within the planned orders behind a changeable figure (x-line). The orders in the long term horizon are calculated on a Projected Inventory PI which is based on the current inventory and future planned requirements and receipts. The RWH subsystem 1400 may perform the following planning steps during execution: Initialize the wheel: to initialize the wheel, the current wheel and the resource are prepared for the Rhythm Wheel scheduling.
All unfixed planned orders scheduled on the resource are deleted to free the capacity for further planning
All fixed orders and process orders not belonging to the wheel design scheduled on the resource are recorded to check if they interfere with the scheduling activities and to log them to the Rhythm Wheel Monitor
For the new planning run, the start position (Anchor Point) of the wheel has to be determined. The start position is defined by the next product in the sequence of the Rhythm Wheel Design after the last converted order or the last planned order which starts before today or the start of the planning horizon, whichever is later.
If there is no anchor order, the RW is started with the first product in the sequence of the design.

Cyclic Planning of the Wheels

### Get the Current Valid Wheel

At the start of each new cycle, the system checks if a new valid wheel is available. If there are two valid wheels available, the one with the higher priority will be used.

### Pre-Calculate the Wheel

In the pre-calculation, the RWH subsystem 1400 may calculate the orders to be scheduled for the current cycle based on the RW Design, the current inventory and the lot size profile of the products. If necessary, orders can be split into different lots based on lot sizes and rounding values. If the overall cycle time is longer than the maximum cycle time from the RWD subsystem 1300, the RWH subsystem 1400 may check if factoring methods are assigned to the wheel and executes them. The result of the pre-calculation step may be passed over to the schedule order step.

### Calculate Make Quantity

The RWH subsystem 1400 differentiates between two decisions: make or skip. These decisions are based on the calculation routine of the different planning method and make quantity calculations: The decision to make or skip the product is therefore based on the netting result different methods for calculating the make quantity per planning method. Two main concepts can be distinguished, bucket and rolling netting. The Project Inventory (PI) may be calculated by netting all receipts & demands from the past until the netting end time

For Net Bucket the demand horizon end time is the:
Start time of the cycle+the cycle plan time+additional demand horizon (if specified in the design).
   For Net Rolling the demand horizon end time is the:
Start time of the each product in the cycle+the cycle plan time+additional demand horizon (if specified in the design).

In the short term horizon the x-line can be set in the RWD subsystem 1300, up to it the calculated demands will omit forecast shares. Furthermore it is required to make sure the actual production quantity is solely based on actual consumption. Therefore, the forecast share of the planned order quantity has to be set to zero at a line-specific number of days before start of production.

The Make Quantity calculation has two basic methods:

Replenishment against Null

IF PI < Null => Make

Planned Make Quantity: Max (P1; Min. make quantity)

ELSE

Skip

ENDIF

Replenishment against MMQ

IF PI < MMQ = > Make

Planned Make Quantity: Max (P1; Min. make quantity)

ELSE

Skip

ENDIF

Fixed Order Processing

After each product, it will be checked if the newly calculated order(s) are overlapping with existing fixed orders from previous planning activities.

Short Term Planning

If specified, the heuristic will reschedule fixed orders in the short-term horizon to optimize the OOE of the resource. Otherwise, it will schedule around the fixed orders by recalculating the dynamic setup times

Mid- and Long-Term Planning

In the long-term planning, fixed orders will be scheduled by recalculating the dynamic setup times. This can lead to gaps in the overall production plan, but is needed to avoid that fixed orders are continuously preponed by every planning run with the effect that the receipt time is much earlier than the demand time.

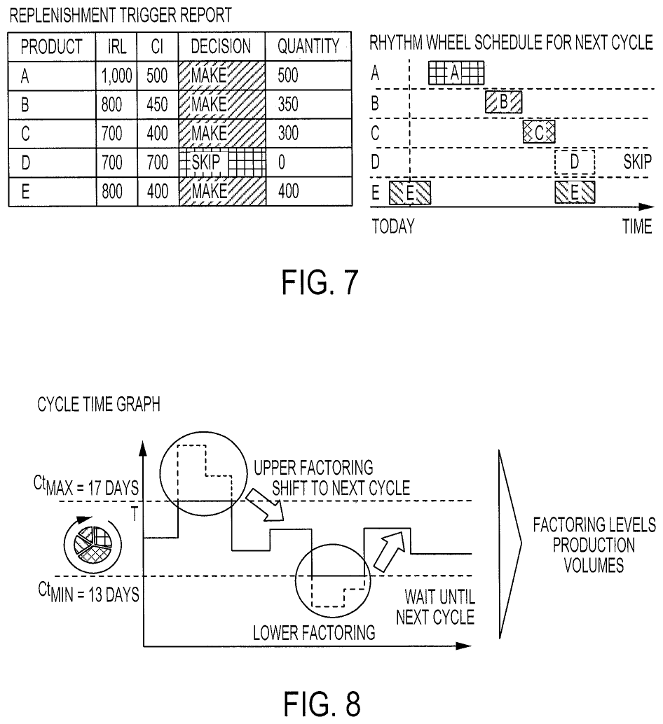

FIG. 7 is an example illustration showing that in case of no demand for a SKU, the RWH subsystem 1400 may skip this SKU during the current cycle and may take it into account during the following cycle again if there is relevant demand available. The same skip-logic may be used within the RWH subsystem when demand in a period can be served with available stock of the product.

Wheel Cycle Time.

Factoring is necessary if the actual required total cycle length of the created production schedule exceeds or falls below the predefined maximum or minimum cycle length. As illustrated in FIG. 8, lower factoring is required if the actual cycle time falls below the minimum cycle time boundary. Upper factoring refers to the shortening of the Rhythm.

When applying lower factoring, idle times are added in order to lengthen the production cycle time. The idle time can be used for maintenance, training, continuous improvement or other activities that are frequently required.

Lower factoring or Minimum Cycle Time Factoring
Postpone factoring
   The end of the cycle is postponed until the cycle reaches its minimum cycle time as specified in the RWD.
Fill up—percentage
   The make quantity of all relevant products is increased by the factor specified in the factoring method of the RWD.
Fill up—adhere to min
   The make quantity of all relevant products is increased by the factor that ensures that the cycle time is higher and as close as possible to the minimum cycle time.

### Upper Factoring or Maximum Cycle Time Factoring

Cut-off factoring
   Cut off orders at end of the cycle, after each order the system checks for cycle time adherence
Percentage factoring
   One order by another is reduce by a proportional factor as specified in the RWD. After each factoring step the adherence to the maximum cycle time is checked.
Preponing
   In case the cycle n−1 was postponed by minimum factoring the cycle n can be preponed until the original end time of cycle n−1 or a maximum duration specified in the RWD.

Possible factoring is overruled by some exception rules: factoring can only be applied to vendor-managed inventory (VMI) products; Make to Order (MTO) products and fixed orders must be excluded from factoring. If products are MTO the production quantity and due dates must coincide with the order quantity and date to deliver on time in full (OTIF). A high degree of VMI products is therefore desirable for the production site in order to flexibly apply factoring as required. Furthermore, lot size rules and minimum make quantities must be taken into account

Customized Factoring

After all make and skip decisions are made, the overall cycle time may be calculated. In the case that it is longer than the defined maximum cycle time, various factoring methods can be used sequentially to reduce the overall cycle time.

### Minimum Cycle Time Factoring

If the cycle time of a wheel is below the minimum cycle time the heuristic will automatically postpone the next cycle to ensure the minimum cycle time is kept. This will result in idle time on the resource.

### Maximum Cycle Time Factoring

If the cycle time exceeds the maximum cycle time after scheduling the orders, a default factoring method will be applied. This method will de-allocate all orders of this cycle starting after the calculated maximum end cycle time.

### Logging

To provide the necessary information for the RWM subsystem 1600, the used RW design and the orders of the cycle are written to the Rhythm Wheel Log 1418.

### Schedule Orders in all Cycles

In the schedule orders step, all products with a make decision will be scheduled in the sequence of the RW Design. For all short-term planning cycles, the heuristic checks if there will be a gap due to fixed orders. The gaps may be closed or rescheduled to start directly after the predecessor order.

Adjustments within Rhythm Wheel Heuristic

The RWH subsystem 1400 may consider the pre-configured SCM parameters, including stock parameters and the production-related Rhythm Wheel design parameters, as well as actual consumption to follow a pull-based SCM operating model. Furthermore, additional production characteristics are considered. For instance, if technical constraints require adherence to fixed lot sizes, production quantities need to be rounded up to multiples of such lot sizes.

Planning and scheduling with Rhythm Wheels is generally based on the replenishment signals provided by the replenishment trigger report. Following the report's make-or-skip decisions and replenishment quantities, planned orders for the upcoming Rhythm Wheel cycles are scheduled according to the predefined Rhythm Wheel sequence from the RWD subsystem 1400.

Below are example main methods with pseudo code of the RWH subsystem 1400 and include methods which have a direct impact to cycle calculation. Input and Output parameters are in Italic letters

| | |
|---|---|
| O | \hat{ }= Output |
| I | \hat{ }= Input |

Main Method
INITIALIZE

Initialize Wheel definition

O: Rhythm Wheel Designs for Resource from Rhythm Wheel Designer

Initialize Planning Parameters

O: Resource
Planning Horizon Start
Planning Horizon End

Initialize master data

O: Resource data
Material data
Product data (e.g. Product Data Structure (PDS),

Initialize transactional data

O: Receipts for products on wheel (e.g. stock, fix receipts/orders) Demands for
products on wheel

Initialize first Wheel

O: Start date & time
Start sequence

DO UNTIL end of Planning Horizon
Get Valid Wheel Design

I: Current time
O: Wheel Design

CALL PRE-CALCULATE CYCLE

I: Wheel Design
O: Production Plan for current Cycle

Finish cycle

ENDDO

Schedule all Cycles

Write Log for all Cycles
PRE-CALCULATE CYCLE
LOOP ALL VALID PRODUCTS IN CYCLE

CALL METHOD FOR MAKE QUANTITY (based on Wheel Design)
IF make quantity < minimum make quantity.

Decision = skip.
CONTINUE. (With next product in wheel).

ELSE.

```
Decision = make.
Get lots per product and make quantity (1:n) based on material master.
LOOP over lots.
  Get Source of Supply
  Calculate duration of lot based on Source of Supply and dynamic setup times
  Calculate end time of lot
  CALL CYCLE_PRE_CALC_FIX_ORDERS
```

I: Production Plan for current Cycle
O: Adjusted Production Plan for current Cycle

```
  Check Source of Supply is still valid
  IF Source of supply of Lot is not valid anymore
```

```
Get new Source of Supply
IF there is no valid Source of Supply.
  Decision = Skip.
  ENDIF.
ENDIF.
```

ENDLOOP.

ENDIF.
ENDLOOP.

CALL FACTORING
CYCLE_PRE_CALC_FIX_ORDERS

LOOP
IF Lot is overlapping with fixed order

IF cycle is short term cycle
Close gap between last order and fixed order

```
  ENDIF.
  Recalculate duration of fixed order with new dynamic setup time
  Recalculate fixed order end time based on new duration
  Recalculate duration of lot with new dynamic setup time
  Recalculate lot end time based on new duration
  Insert fixed order in to lot sequence
ENDIF.
```

ENDLOOP.

Factoring

IF Cycle time > Maximum Cycle Time

Get valid factoring methods by priority
LOOP at Factoring Methods

CALL CUSTOMIZED FACTORING METHOD (...)

I: Production Plan for current Cycle
O: Adjusted Production Plan for current Cycle

IF Cycle End time < Maximum Cycle Time

END Factoring.

ELSE.

IF Factoring reset is flagged.

Reset result of last Factoring Method

ENDIF.

ENDIF.

ENDLOOP.

ENDIF.

Methods for Make Quantity

NET BUCKET

Calculate end time for netting based on cycle start time
Net result = Sum of all Receipts and Demand from the past up
calculate end time
IF Net result > MMQ

Make_Quantity = max (MMQ; Net_result)

ENDIF

Net Rolling MMQ

Calculate end time for netting based on start time of each order
Net result = Sum of all Receipts and Demand from the past up
calculate end time
IF Net > MMQ

Make_Quantity = max (MMQ; Net_result)

ENDIF

Net Bucket Null

Calculate end time for netting based on cycle start time
Net_result = Sum of all Receipts and Demand from the past up
calculate end time
IF Net_result < 0

Make_Quantity = max (MMQ; Net_result)

ENDIF

Net Rolling Null

Calculate end time for netting based on start time of each order
Net_result = Sum of all Receipts and Demand from the past up
calculate end time
IF Net_result < 0

Make_Quantity = max (MMQ; Net_result)

ENDIF

Methods for Default Factoring

POSTPONE

IF cycle end time < cycle minimum time

Next cycle start time = current cycle minimum time

ENDIF.

De-Allocate

LOOP reverse over the orders of cycle

IF Order end time > cycle time maximum.

De-allocate the order.

ENDIF.

ENDLOOP.

Customized Factoring Methods

PREPONE
Set new cycle start time
CALL RECALCULATE_CYCLE_TIMES

Percentage

Get percentage value from Rhythm Wheel Design
LOOP reverse over cycle orders.

Check material master data if product can be factored
IF material can be factored.

Quantity of product is adopted by percentage factor
Get lots for new make quantity (1m) based on material master
Adopt lots of product with new quantities
CALL RECALCULATE_CYCLE_TIMES

ENDIF
IF cycle end time < cycle end time max

END factoring.

ENDIF.

ENDLOP

Cut Off

LOOP reverse over cycle orders.

Check material master data if product can be factored
IF material can be factored.

Cut off last of product
CALL RECALCULATE_CYCLE_TIMES

ENDIF
IF cycle end time < cycle end time max

END factoring.

ENDIF.

ENDLOP

Fill Up Percentage

Get fill up value from Rhythm Wheel Design
LOOP reverse over cycle orders.

Check material master data if product can be filled up
IF material can be filled up

Adopt quantity of product by fill up factor
Get lots for new make quantity (1:n) based on material master
Adopt lots of product with new quantities
CALL RECALCULATE_CYCLE_TIMES

ENDIF
IF cycle end time > cycle end time minimum

END factoring.

ENDIF.

ENDLOP

Fill Up Adhere to Min

Calculate fill up rate based on the ratio (cycle time end - cycle time
minimum, cycle time minimum)
LOOP reverse over cycle orders.

Check material master data if product can be filled up
IF material can be filled up

Adopt quantity of product by fill up factor
Get lots for new make quantity (1:n) based on material master
Adopt lots of product with new quantities
CALL RECALCULATE_CYCLE_TIMES

ENDIF
IF cycle end time > cycle end time minimum

END factoring.

ENDIF.

ENDLOP

Recalculate_Cycle_Times

IF cycle start time changed

Set new start time for first order

ENDIF
LOOP orders in cycle

IF Decision = ‘Make’

Calculate duration of lot based on Source of Supply and dynamic
setup times
Calculate end time of lot
Check validity of Source of Supply
IF valid Source of Supply exists

Adjust pre-calculation

ENDIF.

ELESIF Decision = ‘FIX’

Get next order with decision = ‘Make’
Recalculate order duration based on new dynamic setup time
IF order fits into gap between actual order and fixed order.

Insert order after current sequence

ENDIF

ENDLOOP

Rhythm Wheel Log (RWL)

The Rhythm Wheel Log includes five tables created belonging to a single Rhythm Wheel planning run. All the relevant planning data of a run is logged within these tables. The different tables are merged by a table called /CLS/RWL_VIEW.
/CLS/RWL_RUN—general data of planning run like execution time
/CLS/RWL_WHEEL—data of used Rhythm Wheel design
/CLS/RWL_PRODUCT—product settings per Rhythm Wheel Design
/CLS/RWL CYCLE—data of cycle start and end time, etc.
/CLS/RWL_ORDERS—data of orders scheduled or factored, e.g., make quantities, start and end time, etc.
/CLS/RWL_FACT—data of used factoring methods for each Order
   As soon as the RWH subsystem 1400 has executed, the RWL subsystem 1500 may execute. The RWL subsystem 1500 is used to the production plan, the used Design, the detailed information for each cycle, order/lot created during the heuristic run. RWL subsystem 1500 may also include all factoring events which are executed during the pre-calculation or at the end of a cycle. This information is handed over/made available to the RWM subsystem 1600 by the RWL Log Adapter 1506. Furthermore, this information can be used for integration with other systems, such as:
Data Warehouse 1524
Manufacturing Execution Systems 1522

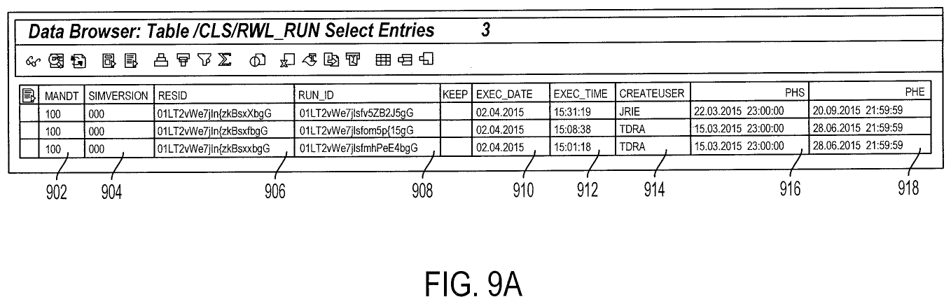

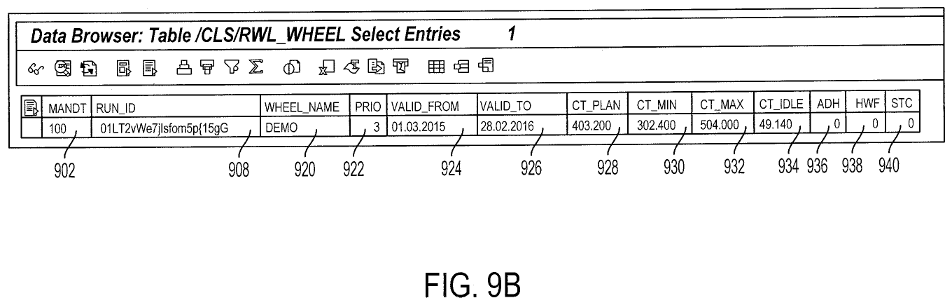

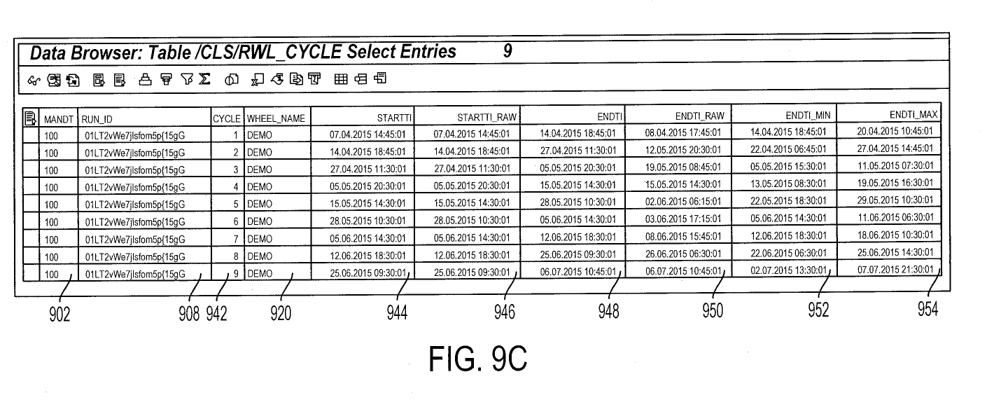

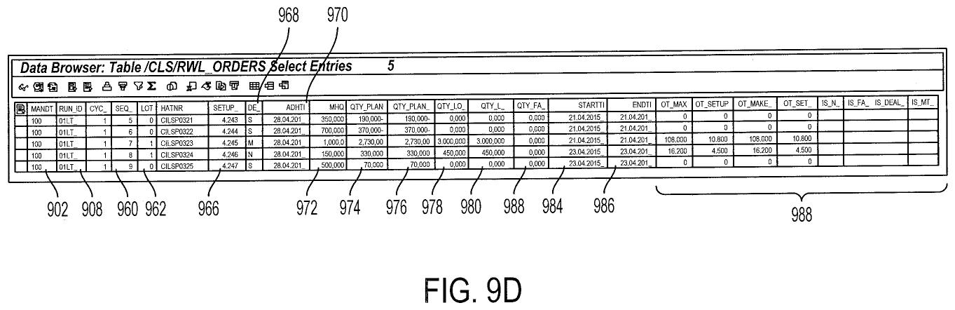

As shown in relation to FIG. 9A, the /CLS/RWL RUN table may comprise the following general data for each planning run:
Mandant 902
Simulation Version 904
Resource ID 906
Run ID 908
Keep (labeled “Keep”) (indicates whether the user wants to save this run even having executed further runs on the same resource)
Execution date 910
User who executed the RW heuristic 914
Planning horizon start 916
Planning horizon end 918

As shown in relation to FIG. 9B, the CLS/RWL_WHEEL table may comprise the following data for each wheel that has been used by the RHh subsystem 1400. All the relevant design parameters are saved:
Mandant 902
Run ID 908
Wheel name 920
Priority 922
Validity From 924, and Validity to 926
Planned cycle time 928
Minimum cycle time 930
Maximum cycle time 932
Planned idle time on resource 934
Additional Demand Horizon 936
Horizon without forecast 938
Short term horizon 940

As shown in relation to FIG. 9C, the /CLS/RWL CYCLE table may comprise the following data for each cycle within a specific wheel that has been used by the RWH subsystem 1400.
Mandant 902
Run ID 908
Cycle number 942
Wheel name 920
Actual cycle start date 944
Cycle start date without factoring (RAW) 946
Actual cycle end date 948
Cycle end date without factoring (RAW) 950
Actual minimum cycle time end date 952
Actual maximum cycle time end date 954

As shown in relation to FIG. 9D, the /CLS/RWL ORDERS table may comprise the following data for each order within a specific cycle.
Mandant 902
Run ID 908
Cycle number (labeled “CYC”)
Sequence (indicated the sequence of the order within the cycle) 960
Lot number for one product within a cycle 962
Material number Setup ID 966
Production Decision (M, S, F) 968
End date of the demand horizon 970
Minimum make quantity 972
Planned quantity 974
Planned quantity factored 976
Quantity lot 978
Quantity lot factored 980
Quantity factored 982
Start date 984
End date 986
Production time, field of 988
Setup time, field of 988
Production time without factoring (RAW), field of 988
Setup time raw without factoring (RAW), field of 988
Indicator: is no Rhythm Wheel material, field of 988
Indicator: is factored, field of 988
Indicator: is deallocated, field of 988
Indicator: is MTO, field of 988

Rhythm Wheel Monitor (RWM)

RWM subsystem 1600 is a tool to control and evaluate the Rhythm Wheel design and the Rhythm Wheel behavior. RWM subsystem 1600 is configured to display and compare the information from the design phase and the results from the RWH subsystem 1400. This ensures an evaluation of the (pre-)designed Rhythm Wheel design as well as continues improvement of the Rhythm Wheel based production. Furthermore the RWM subsystem 1600 may support the planner to analyze and understand the planning results of the Rhythm Wheel Heuristic.
The RWM subsystem 1600 may include an entry screen and four different views for each heuristic run:
Entry screen
Aggregated view
Cycle view
Detailed cycle view
Item view

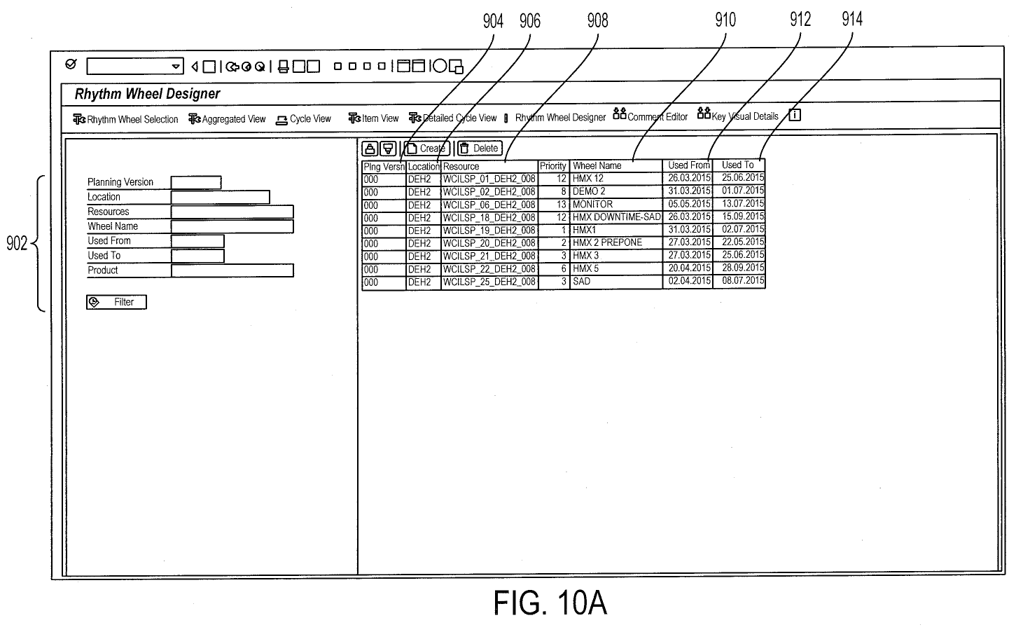

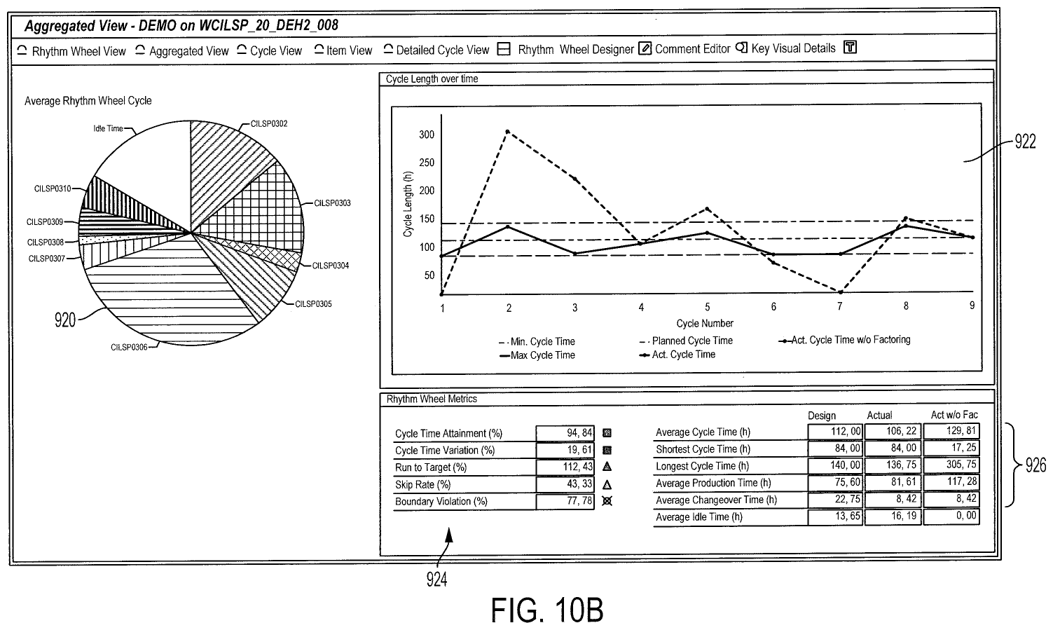

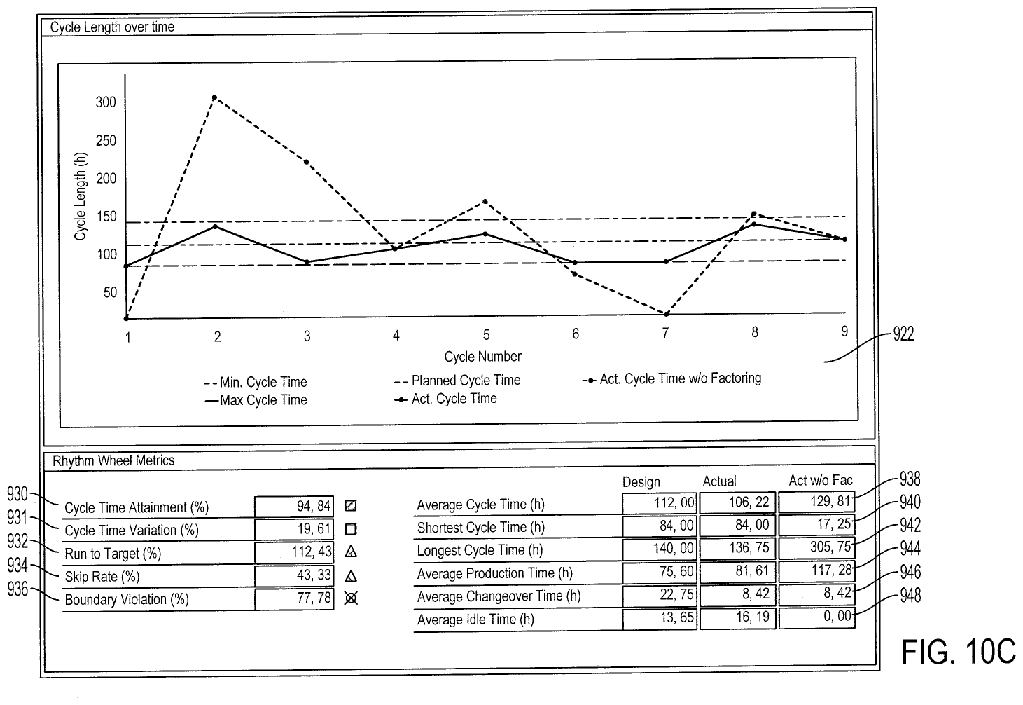

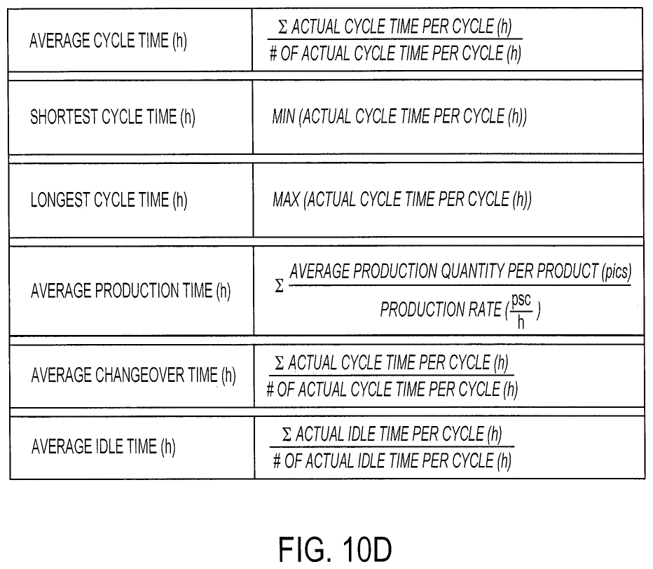

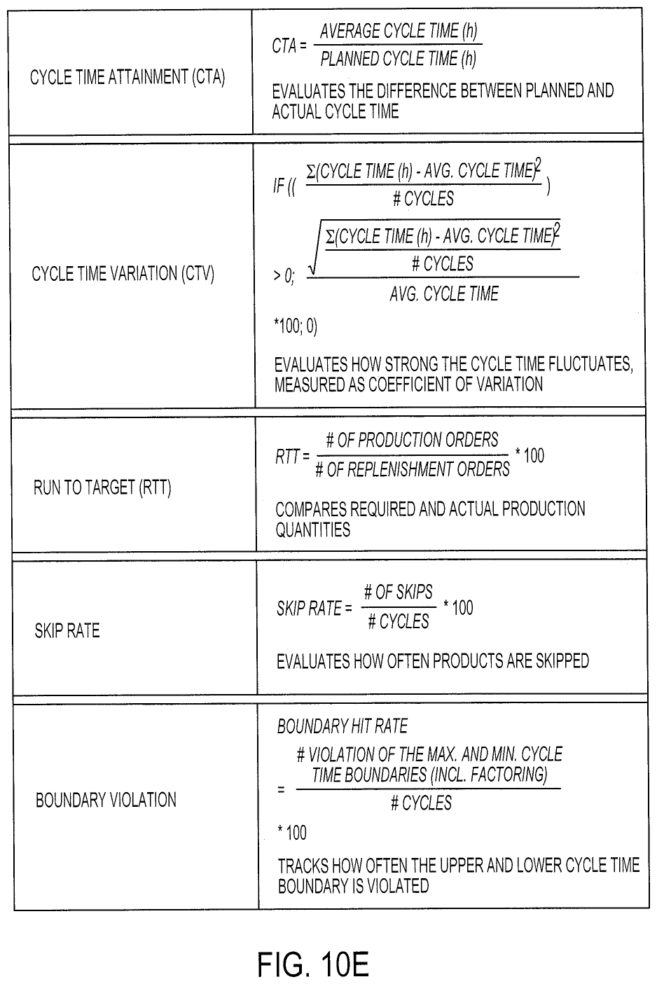

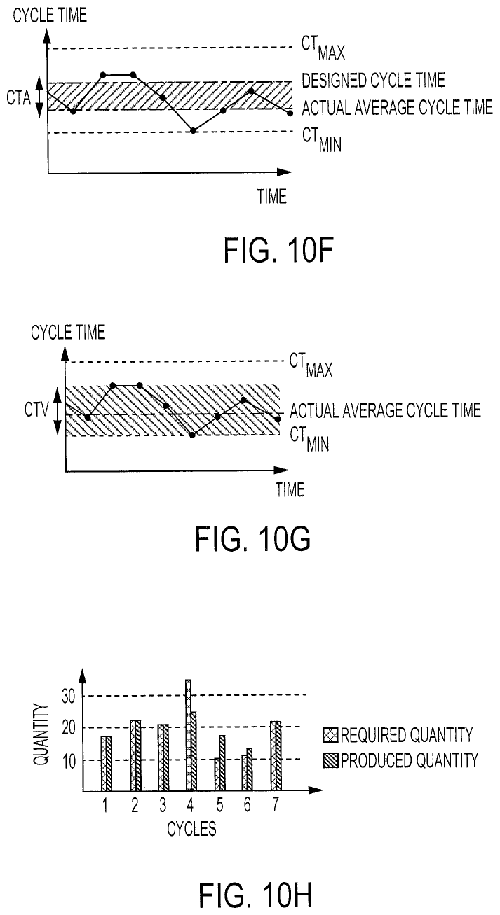

FIG. 10A illustrates an example entry screen for the RWM subsystem 1600. The entry screen, or monitor cockpit, may show, e.g., the latest planning run of RWM subsystem 1600. The user may see a number of eligible wheels. The table with the eligible wheel may show the following columns:
Planning Version 904
Location 906
Resource 908
Priority, labeled “Priority”
Wheel name 910
Used From 912
Used To 914

The user is able to select a Rhythm Wheel range by filtering according to specific selection criteria, shown in input area 902. The number of eligible wheels may be reduced according to the entered selection criteria. The offered selection criteria of input area 902 may include:
Planning version
Location
Resource
Wheel Name
Used From
Used To
Product

After selecting one relevant Wheel, the aggregated view screen is entered, as illustrated in FIG. 10B. The aggregated view screen may comprise a pie chart 920 of the average Rhythm Wheel cycle 922 as well as performance 924 and behavior information 926 of the heuristic run.

As illustrated in FIG. 10C, the aggregated view may include Rhythm Wheel design information from the design phase as well as the average behavior of the Rhythm Wheel with and without factoring. The following KPIs from the Rhythm Wheel design may be displayed in the graph area 922 and/or in the metrics area:
Cycle Time (h) 930
Cycle time variation 931
Run to Target % 932
Skip rate % 934
Boundary violation 936
Minimum Cycle Time (h) (graph)
Maximum Cycle Time (d) (graph)
Average cycle time 938
Shortest cycle time 940
Longest cycle time 942
Ave. Production Time (h) 944
Ave. Changeover Time (h) 946
Ave. Idle Time (h) 948

Furthermore, the average KPIs of the current Rhythm Wheel Heuristic run may be displayed. The KPIs are calculated without the use of any factoring methods as well as KPIs when factoring methods are applied. The calculation of the average KPIs resulting from the RWH subsystem 1500 is illustrated in FIG. 10D. The Monitor calculates the KPIs based on the table entries of the Rhythm Wheel Log 1418 and the resource master data (shift models, etc.) from the Rhythm Wheel Heuristic resource adapter 1506.

In order to measure the quality of a Rhythm Wheel design, the RWM subsystem 1600 may compare the designed Rhythm Wheel with the one that is ultimately scheduled. Therefore, performance KPIs are calculated and displayed by the RWM subsystem 1600. The corresponding formulas and description are illustrated in FIG. 10E. The more important KPIs for production are typically cycle time attainment (CTA), cycle time variation and run to target.

The CTA may be computed as the ratio of average cycle time to planned cycle time. The time needed to complete each Rhythm Wheel cycle is measured from the start of the run of the first product in the Rhythm Wheel sequence to the start of the run of the same product in the next cycle. If there is no demand for this specific product, the time is measured from or to the run of the next product in the Rhythm Wheel sequence. The CTA metric tracks the cycle length over time and evaluates the difference between planned and actual cycle time. It shows how consistently an asset runs according to the designed Rhythm Wheel time and is thus a crucial metric for maintaining synchronization within the end-to-end supply network. Sustainable synchronization is possible only if all supply chain stages or assets adhere to the designed tact. The CTA is computed as the ratio of average cycle time to planned cycle time. The cycle times for consecutive Rhythm Wheel cycles are typically visualized on a process behavior chart, as illustrated in FIG. 10F.

Cycles that are too short are often just as bad as cycles that are too long. Every deviation from the planned production cycle reduces stability and predictability and increases nervousness along the supply chain Therefore, it may be important to monitor rhythm times constantly to be able to identify changes on the demand or supply side as early as possible. If the cycle times are, for example, longer than designed, a variety of potential causes on both the demand and the supply sides could be responsible. The overall demand at the asset might have been higher than expected, perhaps due to demand peaks for some products, or process lead times might have been excessive, perhaps due to unexpectedly long changeover times or low productivity. If deeper analysis shows that the long cycle times have not resulted from short-term events but are rather the product of future trends. An adjustment of the planned cycle time and the cycle time boundaries is required and should be considered in the next iteration of the tactical renewal process.

As illustrated in FIG. 10G, Cycle Time Variation (CTV) evaluates how widely the cycle time fluctuates. While CTA is intended to indicate the degree of adherence to the plan by measuring the distance to the planned cycle time in every production cycle, CTV focuses solely on the variability of the cycle time. Therefore, CTV is defined as the coefficient of variation of the cycle time, which is the ratio of the standard deviation of the cycle time to its mean.

Transparency regarding the behavior of cycle times is important for determining the optimal amount of safety stock that has to be held to cover variability of both demand and supply. If no agility stock process is in place as a general principle, it is recommended orienting the safety stock toward the longest cycle time measured in order to mitigate the risk of stock-outs due to extraordinarily long production cycles. Moreover, the cycle time boundaries should be set in accordance with fluctuations of the cycle time. The greater the cycle time variation, the less strictly should the cycle time boundaries be set. Thus, existing variability is at least partly buffered at the asset rather than being buffered entirely in inventories. Experience shows that the CTV depends heavily on the heterogeneity of the product portfolio at the asset. The more heterogeneous the mix is, the higher the cycle time variation typically will be. The allowed ranges need to be defined accordingly on a case-by-case basis. Generally, too much variation can be the consequence of higher-than-expected demand variability, unbalanced production rhythms, or cycle time boundaries that are too lax.

As illustrated in FIG. 10H, Run To Target (RTT) may track and compare the required replenishment and the actual production quantities in every Rhythm Wheel cycle. RTT shows how consistently the quantities are produced according to the replenishment trigger. This KPI evaluates how efficiently planned make quantities and cycle time boundaries have been chosen. The RTT metric will indicate, for example, whether products are constantly under-produced such that the required replenishment quantities are not delivered by production. This can result in compromised service levels, since the demanded quantities are not replenished in the required way. A potential source of such a scenario could be that estimated demand per cycle does not match reality. Potential reasons could be either changes in the demand pattern or poor forecasting accuracy. By comparing the KPIs of the Rhythm Wheel Design and the actual ones generated from the Heuristic run, necessary information can be retrieved and used for further adaption of the Rhythm Wheel design parameters.

As illustrated in FIG. 11, the RWM subsystem 1600 may deliver cycle-specific metrics and provides an overview of all cycles. The following KPIs may be displayed for each cycle:
Cycle start date
Cycle end date
Actual cycle time
Actual production time
Actual changeover time
Idle time
Number of skipped products
Number of factored products
   Additionally on the left side of the screen, the KPIs from the wheel design are shown to enable a direct comparison of the designed cycle KPIs and the actual ones.
   The input data may be extracted from the Rhythm Wheel Log 1418, e.g., production and changeover time. The idle time is calculated with the help of the Log as well as resource shift data from the resource adapter.

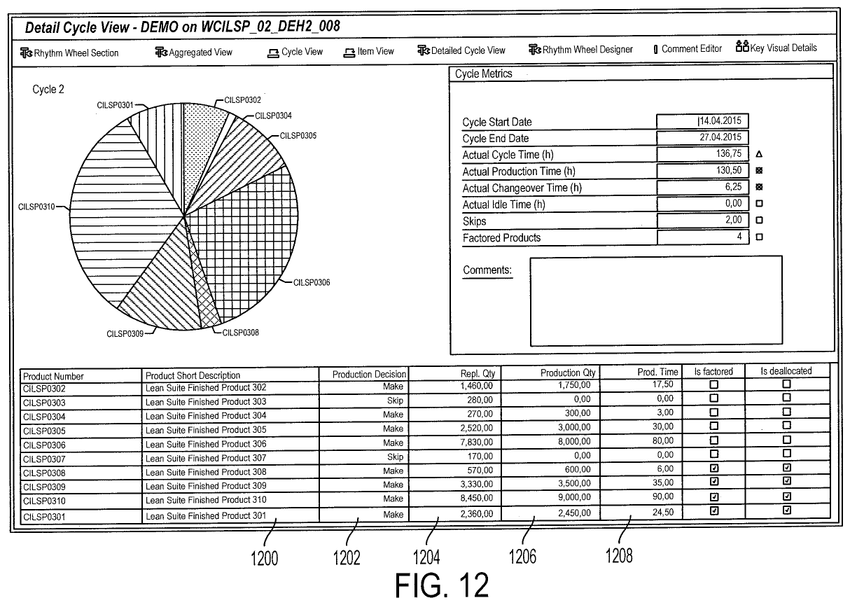

FIG. 12 illustrates a detailed cycle view that may include additional detailed information of each cycle. For each product 1200 of the cycle a production decision 1202 is shown which indicated whether it was a make (M) or skip (S) decision, or whether it was a fixed order or a product (F). Additionally the replenishment 1204 and production 1206 quantity, production time 1208 and whether the product was factored and/or de-allocated. The input data may be extracted from the Rhythm Wheel Log 1418.

The LEAN Suite implements certain lean planning concepts (e.g., “Lean Supply Chain Planning: The New Supply Chain Management Paradigm for Process Industries to Master Today's Vuca World” by Dr. Josef Packowski, ISBN-13: 978-1482205336, incorporated by reference herein) in an integrated application.

Although the foregoing description has been described by reference to various examples, it is to be understood that modifications and alterations in the structure and arrangement of those examples may be achieved by those skilled in the art and that such modifications and alterations can be practiced in the spirit of the appended claims. The examples herein are merely illustrative and are not meant to be an exhaustive list of all possible designs, examples or modifications of the disclosure.

What is claimed is:

1. A system for advanced material resource planning and capacity resource planning, comprising:
a rhythm wheel designer subsystem executing on a supply chain planning system that creates an optimal rhythm wheel design based on actual production requirements and availability of production resources using at least one sequence optimization algorithm of a plurality of sequence optimization algorithms, selectable by a user; and
a rhythm wheel heuristic subsystem executing on an enterprise resource system that initializes a wheel including planning parameters, pre-calculate cycles including netting and factoring, schedules a cycle and produces a rhythm wheel log based on the optimal rhythm wheel design for controlling a production manufacturing process.

2. The system of claim 1, further comprising a rhythm wheel log subsystem that creates a sequence optimized material resources planning (MRP) and capacity requirements planning (CRP) production plan based on the rhythm wheel log for controlling a production manufacturing process.

3. The system of claim 2, wherein the rhythm wheel log subsystem outputs key performance indicators to a data warehouse.

4. The system of claim 2, further comprising a rhythm wheel monitor subsystem to accept data from the rhythm wheel log subsystem to display planning results and key performance indicators to one or more display devices.

5. The system of claim 1, wherein the at least one sequence optimization algorithm comprises a plurality of optimization algorithms selected from the group of: sequence optimization, ant colony sequence optimization, simulated annealing sequence optimization and absolute minimum sequence optimization.

6. The system of claim 1, wherein the rhythm wheel heuristic subsystem performs factoring if an actual required total cycle length of a created production schedule exceeds or falls below a predefined maximum or minimum cycle length.

7. The system of claim 6, wherein the factoring reduces replenishment quantities which cover actual net requirements to fit actual constraints.

8. The system of claim 7, wherein the actual constraints comprise one or more of: resource capacity, component availability and order prioritization cycle time definitions.

9. The system of claim 1, wherein the rhythm wheel designer subsystem provides selectable optimization techniques for calculation of sequences and optimal cycle time.

10. The system of claim 9, wherein the selectable optimization techniques for calculation of sequences and optimal cycle time include set-up time for overall equipment efficiency (OEE).

11. The system of claim 9, wherein the selectable optimization techniques for calculation of sequences and optimal cycle time include production costs.

12. The system of claim 1, wherein the rhythm wheel designer subsystem supports a classic wheel rhythm wheel, a breathing rhythm wheel and a high-mix rhythm wheel.

13. The system of claim 1, wherein the rhythm wheel designer subsystem outputs a centralized status display area to convey: a first status indicator that at least one product data structure (PDS) exists which is valid for a whole wheel horizon, a second status indicator during the whole wheel horizon at any time at least one valid PDS exists and a third status indicator indicating that there is at least one time period where no valid PDS exists.

14. A system for advanced material resource planning and capacity resource planning, comprising:
a rhythm wheel designer subsystem executing on a supply chain planning system that creates an optimal rhythm wheel design based on actual production requirements and availability of production resources using at least one sequence optimization algorithm of a plurality of sequence optimization algorithms, selectable by a user;
a rhythm wheel heuristic subsystem executing on the supply chain planning system that initializes a wheel including planning parameters, pre-calculate cycles including netting and factoring, schedules a cycle and produces a rhythm wheel log based on the optimal rhythm wheel design for controlling a production manufacturing process;
a rhythm wheel log subsystem executing on the supply chain planning system that creates a sequence optimized material resources planning (MRP) and capacity requirements planning (CRP) production plan based on the wheel log based on the rhythm wheel log for controlling a production manufacturing process; and
a rhythm wheel monitor subsystem executing on the supply chain planning system to accept data from the rhythm wheel log subsystem to display planning results and key performance indicators to one or more display devices for use by a user,
wherein the system permits a single planning step to create a sequence optimized material requirements planning (MRP) and capacity requirements planning log based on the optimal rhythm wheel design and actual net requirements including factoring against existing constraints.

15. The system of claim 14, wherein the rhythm wheel heuristic subsystem performs factoring if an actual required total cycle length of a created production schedule exceeds or falls below a predefined maximum or minimum cycle length.

16. A method for advanced material resource planning and capacity resource planning comprising:
creating on a supply chain planning system an optimal rhythm wheel design based on actual production requirements and availability of production resources using at least one sequence optimization algorithm of a plurality of sequence optimization algorithms, selectable by a user; and
initializing a wheel including planning parameters, pre-calculating cycles including netting and factoring, scheduling a cycle and producing a rhythm wheel log based on the optimal rhythm wheel design for controlling a production manufacturing process.

17. The method of claim 16, further comprising creating a sequence optimized material resources planning (MRP) and capacity requirements planning (CRP) production plan based on the rhythm wheel log for controlling a production manufacturing process.

18. The method of claim 16, further comprising outputting key performance indicators to a data warehouse.

19. The method of claim 16, further comprising accepting data from the rhythm wheel log subsystem and displaying planning results and key performance indicators to one or more display devices.

20. The method of claim 16, wherein the at least one sequence optimization algorithm comprises a plurality of optimization algorithms selected from the group of: sequence optimization, ant colony sequence optimization, simulated annealing sequence optimization and absolute minimum sequence optimization.
